(19) United States
(12) Patent Application Publication
(10) Pub. No.: US 2016/0277974 A1
(43) Pub. Date: Sep. 22, 2016

(54) Controlling the Operation of Mobile Terminals with Respect to Multiple Radio Access Technologies

(71) Applicant: Telefonaktiebolaget L M Ericsson (publ), Stockholm (SE)

(72) Inventors: Håkan Persson, Solna (SE); Joakim Bergström, Stockholm (SE); Tomas Hedberg, Stockholm (SE); Niklas Johansson, Sollentuna (SE); Christofer Lindheimer, Linköping (SE); Filip Mestanov, Sollentuna (SE); Håkan Palm, Växjö (SE); Stephen Rayment, Ottawa (CA); Dinand Roeland, Sollentuna (SE); Stefan Rommer, Västra Frölunda (SE); Ivo Sedlacek, Hovorcovice (CZ); Mattias Tan Bergström, Stockholm (SE); Oumer Teyeb, Solna (SE); Samy Touati, San Jose, CA (US); Jari Vikberg, Järna (SE); Yu Wang, Solna (SE)

(21) Appl. No.: 14/777,999

(22) PCT Filed: Jan. 16, 2014
(86) PCT No.: PCT/SE2014/050040

§ 371 Date: Sep. 17, 2015

Related U.S. Application Data
(60) Provisional application No. 61/803,618, filed on Mar. 20, 2013.
(60) Provisional application No. 61/811,940, filed on Apr. 15, 2013.

(51) Int. Cl. H04W 36/00; H04W 48/16

(52) U.S. Cl. CPC H04W 36/0022; H04W 48/16

(57) ABSTRACT

There is provided a method of operating a terminal in a first network that is operating according to a first radio access technology, RAT, the method comprising receiving (171) a message from the first network, the message being for configuring the terminal with a set of criteria for enabling, detecting and/or performing measurements over a second RAT; determining (173) if the set of criteria in the message are fulfilled by a network operating according to a second RAT; and steering (175) all or a subset of the traffic for the terminal to the network operating according to the second RAT if the set of criteria are fulfilled.

### TECHNICAL FIELD

The present disclosure is generally related to wireless communication systems and is more particularly related to techniques for controlling the operation of mobile terminals with respect to the use of multiple radio access technologies (RATs), such as a wide area communication technology and a wireless local area network (WLAN) technology.

### BACKGROUND

The wireless local-area network (WLAN) technology known as “Wi-Fi” has been standardized by IEEE in the 802.11 series of specifications (i.e., as “IEEE Standard for Information technology—Telecommunications and information exchange between systems. Local and metropolitan area networks—Specific requirements. Part 11: Wireless LAN Medium Access Control (MAC) and Physical Layer (PHY) Specifications”). As currently specified, Wi-Fi systems are primarily operated in the 2.4 GHz and 5 GHz bands.

The IEEE 802.11 specifications regulate the functions and operations of the Wi-Fi access points or wireless terminals, collectively known as “stations” or “STA,” in the IEEE 802.11, including the physical layer protocols, Medium Access Control (MAC) layer protocols, and other aspects needed to secure compatibility and inter-operability between access points and portable terminals. Because Wi-Fi is generally operated in unlicensed bands, communication over Wi-Fi may be subject to interference sources from any number of both known and unknown devices. Wi-Fi is commonly used as wireless extensions to fixed broadband access, e.g., in domestic environments and in so-called hotspots, like airports, train stations and restaurants.

Recently, Wi-Fi has been subject to increased interest from cellular network operators, who are studying the possibility of using Wi-Fi for purposes beyond its conventional role as an extension to fixed broadband access. These operators are responding to the ever-increasing market demands for wireless bandwidth, and are interested in using Wi-Fi technology as an extension of, or alternative to, cellular radio access network technologies. Cellular operators that are currently serving mobile users with, for example, any of the technologies standardized by the 3rd-Generation Partnership Project (3GPP), including the radio-access technologies known as Long-Term Evolution (LTE), Universal Mobile Telecommunications System (UMTS)/Wideband Code-Division Multiple Access (WCDMA), High Speed Packet Access (HSPA) and Global System for Mobile Communications (GSM), see Wi-Fi as a wireless technology that can provide good additional support for users in their regular cellular networks.

As used herein, the term “operator-controlled Wi-Fi” indicates a Wi-Fi deployment that on some level is integrated with a cellular network operator's existing network, where the operator's radio access network(s) and one or more Wi-Fi wireless access points may even be connected to the same core network (CN) and provide the same or overlapping services. Currently, several standardization organizations are intensely active in the area of operator-controlled Wi-Fi. In 3GPP, for example, activities to connect Wi-Fi access points to the 3GPP-specified core network are being pursued. In the Wi-Fi alliance (WFA), activities related to certification of Wi-Fi products are undertaken, which to some extent is also driven from the need to make Wi-Fi a viable wireless technology for cellular operators to support high bandwidth offerings in their networks. In these standardization efforts, the term “Wi-Fi offload” is commonly used and indicates that cellular network operators seek means to offload traffic from their cellular networks to Wi-Fi, e.g., during peak-traffic-hours and in situations when the cellular network needs to be off-loaded for one reason or another, e.g., to provide a requested quality-of-service, to maximize bandwidth, or simply for improved coverage.

### Traffic Offloading Using WI-Fi

As noted above, using Wi-Fi/WLAN (the two terms are used interchangeably throughout this application) to offload traffic from the mobile networks is becoming more and more interesting from both the operator's and end user's points of view. Some of the reasons for this tendency are:
Additional frequency: by using Wi-Fi, operators can access an additional 85 MHz of radio bandwidth in the 2.4 GHz band and another (close to) 500 MHz in the 5 GHz band.
Cost: From the operator's point of view, Wi-Fi uses unlicensed frequency that is free of charge. On top of that, the cost of Wi-Fi Access Points (APs), both from capital expense (CAPEX) and operational expenses (OPEX) aspects, can be lower than that of a 3GPP base station (BS)/enhanced NodeB (eNB). Operators can also take advantage of already deployed APs that are already deployed in hotspots such as train stations, airports, stadiums, shopping malls, etc. Most end users are also currently used to having Wi-Fi for free at home (as home broadband subscriptions are usually flat rate) and public places.
Terminal support: Many User Equipments (UEs), including virtually all smartphones, and other portable devices currently available in the market support Wi-Fi. In the Wi-Fi world, the term Station (STA) is used instead of UE, and as such the terms UE, STA and terminal are used interchangeably in this document.
High data rate: Under low interference conditions and assuming the user is close to the Wi-Fi AP, Wi-Fi can provide high peak data rates (for example, theoretically up to 600 Mbps for IEEE 802.11n deployments with MIMO (Multiple Input Multiple Output)).

For a wireless operator, offering a mix of two technologies that have been standardized in isolation from each other raises the challenge of providing intelligent mechanisms for co-existence. One area that needs these intelligent mechanisms is connection management.

Although, many of today's portable wireless devices (referred to hereinafter as “user equipments” or “UEs”) support Wi-Fi in addition to one or several 3GPP cellular technologies, in many cases, however, these terminals essentially behave as two separate devices, from a radio access perspective. The 3GPP radio access network and the UE-based modems and protocols that are operating pursuant to the 3GPP specifications are generally unaware of the wireless access Wi-Fi protocols and modems that may be simultaneously operating pursuant to the 802.11 specifications. Techniques for coordinated control of these multiple radio-access technologies are needed.

A very simplified Wi-Fi architecture is illustrated in FIG. 1 and FIG. 2. On the user plane (1), a very lean architecture is employed, where the UE/STA 20 is connected to the Wi-Fi Access Point (AP) 22, which can directly be connected to the Internet 24 and a remote application or service 26. In the control plane (FIG. 2), an Access point Controller (AC) 28 handles the management of the AP 22. One AC 28 usually handles the management of several APs 22. Security/authentication of users is handled via an Authentication, Authorization and Accounting (AAA) entity, which is shown as a RADIUS server 30 in FIG. 2. Remote Administration Dial In User Service (RADIUS) is the most widely used network protocol for providing a centralized AAA management (and is described in RFC 2865 by The Internet Engineering Task Force (IETF), which is available from http://www.ietf.org/rfc/rfc2865.txt).

### Access Network Discovery and Selection Function

The Access Network Discovery and Selection Function (ANDSF) is an entity defined by 3GPP for providing access discovery information as well as mobility and routing policies to the UE. ANDSF is a new entity added to the 3GPP architecture in Release 8 of 3GPP TS 23.402 (See “Architecture Enhancements for non-3GPP Accesses,” 3GPP TS 23.402, v. 11.4.0 (September 2012), available at www.3gpp.org). A simplified ANDSF architecture is depicted in FIG. 3. As shown in the figure, the ANDSF server 40 is provided that is added to a 3GPP network (that comprises one or more eNBs 42 and a gateway (GW) 44) and is only connected to the UE 46, and its main goal is to provide the UE 46 with access network information in a resource efficient and secure manner. The communication between the UE 46 and the ANDSF server 40 is defined as an IP-based S14-interface 48. A Wi-Fi AP 50 is also shown in FIG. 3, with the AP 50 being connected to the GW 44.

By supplying information about both available 3GPP and non-3GPP access networks to the UE 46, the ANDSF server 40 enables an energy-efficient mechanism of network discovery, where the UE 46 can avoid continuous and energy-consuming background scanning. Furthermore, the ANDSF provides the mobile operators with a tool for the implementation of flexible and efficient UE steering of access mechanisms, where policy control can guide UEs 46 to select one particular radio access network (RAN) over another. Note that this may be an overstatement if ANDSF is implemented as an “app”, since it then relies on operating system (OS) support and prioritization of ANDSF in relation to other “apps”. This condition may be only partly fulfilled, which thus makes the control of the UE 46 via the ANDSF somewhat unreliable.

The ANDSF supplies three types of information—discovery information, inter-system mobility policies (ISMP) and inter-system routing policies (ISRP). All these are summarized and implemented via ANDSF managed objects (MO), which are communicated to the UE.

The discovery information provides the UE with information regarding the availability of different RATs in the UE's vicinity. This helps the UE to discover available (3GPP and) non-3GPP access networks without the burden of continuous background scanning. Inter-System Mobility Policies (ISMP) are policies which guide the UE to select the most preferable 3GPP or non-3GPP access. The ISMP are used for UEs that access a single access (3GPP or Wi-Fi) at a time. The ISMP information specifies the behaviour of UEs that can be connected to only one access network at a given time (either 3GPP, WLAN, WiMAX, etc). If the UE, however, supports connection to several access networks at the same time, the operator can use the third type of information, ISRP, to increase the granularity of the RAN selection. In that case, the UEs will be provided with policies that specify how the traffic flows should be distributed over the different RAN. For example, voice might be only allowed to be carried over 3GPP radio access (RA), while Internet video streaming and best-effort traffic can be routed via WLAN. The ANDSF provides mobile operators with a tool to determine how the UEs connect to different RANs, and hence allows them to add more flexibility in their traffic planning.

### Hotspot 2.0

Different standards organizations have started to recognize the needs for an enhanced user experience for Wi-Fi access, this process being driven by 3GPP operators. An example of this is the Wi-Fi Alliance with the Hot-Spot 2.0 (HS2.0) initiative, now officially called PassPoint (“Hotspot 2.0 (Release 1) Technical Specification”, Wi-Fi Alliance® Technical Committee Hotspot 2.0 Technical Task Group, V 1.0.0). HS2.0 is primarily geared toward Wi-Fi networks. HS2.0 builds on IEEE 802.11u, and adds requirements on authentication mechanisms and auto-provisioning support.

The momentum of Hot-Spot 2.0 is due to its roaming support, its mandatory security requirements and for the level of control it provides over the terminal for network discovery and selection. Even if the current release of HS2.0 is not geared toward 3GPP interworking, 3GPP operators are trying to introduce additional traffic steering capabilities, leveraging HS2.0 802.11u mechanisms.

HS2.0 contains the following procedures:
1. Discovery: where the terminal discovers the Wi-Fi network, and probes it for HS2.0 support, using 802.11u and HS 2.0 extensions.
2. Registration is performed by the terminal toward the Wi-Fi Hot-spot network if there is no valid subscription for that network.
3. Provisioning: Policy related to the created account is pushed toward the terminal. This only takes place when a registration takes place.
4. Access: cover the requirements and procedures to associate with a HS2.0 Wi-Fi network.

One of the attractive aspects of HS2.0 is that it provides information for the STA that can be used to evaluate the load of the Wi-Fi network before attempting the authentication process, thereby avoid unnecessary connections to a highly loaded Wi-Fi network. The load conditions that the STA can evaluate are the following:

BSS Load Element—
This is actually a part of the original IEEE 802.11 standard and provides information about the AP population and the current over-the-air traffic levels, as shown in FIG. 4. It is obtained either via a Beacon or a Query Response frame and is used for vendor-specific AP-selection algorithms. The element is described in detail in Chapter 8.4.2.30 of IEEE 802.11. The most relevant field is the “Channel Utilization” field, which states the amount of time that the AP senses the medium as busy.

WAN Metrics Element—
This is one of the extra features that HotSpot™ 2.0 adds to the IEEE 802.11u amendment. The element, illustrated in FIG. 5, can be obtained via an access network query protocol (ANQP) query (by requesting the element “ANQP Vendor Specific list”) and it provides information about the AP's uplink/downlink wide area network (WAN) (backhaul) speed, as well as the uplink/downlink load. The element is described in detail in Chapter 4.4 of the HS2.0 specification.

With the proliferation of devices that have both Wi-Fi and 3GPP mobile broadband support, offloading traffic to the Wi-Fi network is becoming very interesting, both from the user's and the operator's perspectives. The main difference between traffic steering in the Wi-Fi case as compared to steering between 3GPP networks (or 3GPP-“friendly” networks such as CDMA2000) is that it is the terminal that decides when it shall select a Wi-Fi Access Point (AP), while in the latter case it is the network that is in charge of the network access decisions. Due to technical and historical reasons, the Wi-Fi deployment scenario is in many cases fundamentally different than the cellular deployment. For this reason, special considerations have to be made when integrating Wi-Fi to 3GPP networks. This disclosure focuses on several aspects of integrating Wi-Fi to 3GPP networks, in order to realize optimal steering of traffic while considering both the end user's as well as the network's performance.

### Wi-Fi/3GPP Integration Mechanisms

### No Integration—

Most current Wi-Fi deployments are totally separate from mobile networks, and are to be seen as non-integrated (see FIG. 6). From the terminal 60 perspective, most mobile operating systems (OS) for UEs such as Android and iOS support a simple Wi-Fi offloading mechanism, where the UEs 60 immediately switch all their PS (Packet Switched) bearers to a Wi-Fi network 62 from a fixed network 64 upon a detection of such a Wi-Fi network with a certain signal level. The decision to offload to a Wi-Fi network or not is referred henceforth as access selection strategy or access network selection and the aforementioned strategy of selecting Wi-Fi whenever such a network is detected is known as “Wi-Fi-if-coverage”.

There are several drawbacks of the Wi-Fi-if-coverage strategy (illustrated in FIG. 7):
Though the user/UE 60 can save previous passcodes for already accessed Wi-Fi Access Points (APs) 62, hotspot login for previously unaccessed APs usually requires user intervention, either by entering the passcode in Wi-Fi connection manager or using a web interface.
Interruptions of ongoing services can occur due to the change of IP address when the UE 60 switches to the Wi-Fi network 62. For example, a user who started a VoIP call while connected to a mobile network 64 is likely to experience call drop when arriving home and the UE switching to the Wi-Fi network 62 automatically. Some applications are smart enough to handle this and to survive the IP address change, but the majority of current applications cannot. It also places a lot of burden on application developers if they have to ensure service continuity.
No consideration of expected radio performance is made, and this can lead to a UE 60 being handed over from a high data rate mobile network link to a low data rate via the Wi-Fi link. Even though the UE's OS or some high level software is smart enough to make the offload decisions only when the signal level on the Wi-Fi network 62 is considerably better than the mobile network link, there can still be limitations on the backhaul (e.g. an xDSL connection) that the Wi-Fi AP 62 is using that may end up being the bottle neck.
No consideration of the load conditions in the mobile network 64 and Wi-Fi network 62 is made. As a result, the UE 60 might still be offloaded to a Wi-Fi AP 62 that is serving several UEs 60 while the mobile network 64 (e.g., LTE, 3G) that it was previously connected to is rather unloaded.
No consideration of the UE's mobility is made. Due to this, a fast moving UE 60 can end up being offloaded to a Wi-Fi AP 62 for a short duration, just to be handed over back to the mobile network 64. This is especially a problem in scenarios like cafes with open Wi-Fi, where a user walking by or even driving by the cafe might be affected by this. Such ‘ping pong’ between the Wi-Fi network 62 and mobile network 64 can cause service interruptions as well as generate considerable unnecessary signalling (e.g. towards authentication servers).

In order to combat these problems, several Wi-Fi/3GPP integration mechanisms have been proposed.

### Common Authentication—

The idea behind common authentication is based on the use of automatic subscriber identity module (SIM)-based authentication in both access types. Extensible Authentication Protocol (EAP) is an authentication framework that provides support for the different authentication methods. Described by the IETF document RFC 3748 and (available from http://tools.ietf.org/html/rfc3748) later updated by RFC 5247 (available from http://tools.ietf.org/html/rfc5247), this protocol is carried directly over data-link layer (DLL) and is currently widely deployed in WLANs. The EAP framework specifies over 40 different methods for authentication, and EAP-SIM (Subscriber Identity Module) is the one that is becoming widely available in UEs and networks. FIG. 8 illustrates common authentication via EAP-SIM. A SIM 66 is shown for the UE 60 that is used in the common authentication of the user to the Wi-Fi network 62 and fixed network 64. The main benefit of common authentication is that the user doesn't necessarily have to be actively involved in the authentication process, which will increase the chances of more traffic to be steered to the Wi-Fi side, paving the way for network centric control.

### User Plane Integration—

Wi-Fi user plane integration provides the mobile operator the opportunity to provide the same services, like parental control and subscription based payment methods, for the end users when connected both via 3GPP and via Wi-Fi. The solutions also include the possibility to offload parts of the user plane from the mobile core so that not all traffic needs to be brought to the mobile core network.

Different solutions are being standardized in 3GPP. Overlay solutions (S2b, S2c) are specified since 3GPP Rel-8, while integration solutions (S2a) are currently a work-in-progress (S2a, S2b, S2c indicate the 3GPP interface/reference point name towards the PDN-GW). FIG. 9 and FIG. 10 show a high level view and an architectural overview of user plane integration, respectively. With user plane integration, it is possible to access operator services like parental control, multimedia messaging (MMS), subscription payments and it is possible to still offload selected parts of traffic.

### RAN Level Integration—

A further level of integration can be realized via access selection based on RAN information on both 3GPP and Wi-Fi, in addition to the common authentication and user plane integration methods discussed above.

### Wi-Fi/3GPP Deployment Scenarios

The different deployment scenarios for Wi-Fi can be categorized into three groups as Private Wi-Fi 70, Public Wi-Fi 72 and Integrated Wi-Fi 74. This is illustrated in FIG. 11, and the different scenarios are explained below:
Private Wi-Fi 70 (residential, enterprise)
   Access selection controlled by end user (so end user is aware of the access selection)
   Operator services supported over the top (OTT) and/or with S2b (S2c)
   No charging
   No operator control
Public Wi-Fi 72 (3^{rd} Party, Operator/Shared Hotspot)
   Access selection depending on roaming agreements, end user, etc.
   Possible to use HS2.0 mechanism for authentication (extensible authentication protocol for GSM SIM, EAP-SIM) and roaming
      Access selection based on operator policies (ANDSF/HS2.0) may be supported in the future terminals.
   Operator services supported over the top (OTT) and/or with S2b (52c)
   Different charging models typically used in Wi-Fi compared to cellular (e.g. flat-rate, bucket charging).
Integrated Wi-Fi 74 (Wi-Fi as a part of Heterogeneous network)
   Wi-Fi network is managed by the operator.
   Access selection controlled by operator via network based mechanism and/or ANDSF/HS2.0 policies sent to the UE
   Seamless Wi-Fi offloading experience for end user (i.e. user does not need to care about or know which interfaces are used for the traffic)
   All operator services supported using smart service selection and user plane integration (e.g. S2a, S2b over trusted W-Fi)
   Possibility to optimize network performance and end user experience
   Future support for seamless IP session continuity
   Similar charging model in Wi-Fi and cellular, so integrated charging for both services.

It will be noted that moving from private Wi-Fi 70 to public Wi-Fi 72 and then to integrated Wi-Fi 74 provides improvements in end user experience, network utilisation and operator control (indicated by arrow 76).

For the Private and the Public Wi-Fi (Wi-Fi roaming) scenarios it is expected that only limited network control can be used due to e.g. different charging models typically used in Wi-Fi compared to cellular. Examples of network control mechanisms that could be also applicable in these scenarios are ANDSF and H52.0.

### SUMMARY

One issue with currently existing technologies is that the terminal decides when to move from a 3GPP network (or other cellular network) to a WLAN based on its own criteria or criteria downloaded (or broadcast) from the network such as via Access Network Discovery and Selection Function (ANDSF) or by other applications. This may result in a lot of signalling when many terminals move to WLAN at the same time when suddenly a criterion is fulfilled (with all or some bearers if a policy restricts which services should move), and/or when terminals move whenever a terminal enters coverage of a WLAN AP. The resulting load distribution between WLAN and 3GPP may not be the preferred distribution, and quality of service may even be worse than before.

In other words, the network cannot individually control when a terminal goes to WLAN and moves some or all of its ongoing bearers/connections. There could be mass-toggling with high signalling load, resulting in non-optimal usage of the wide area radio network with possibly lower quality of service to users.

Several embodiments, therefore, include methods in a mobile terminal and a wireless network for enabling the 3GPP network (such as the eNB, radio network controller (RNC) or base station controller (BSC) nodes) to control if and when a terminal (a terminal can also be called UE, mobile station (MS) and in Wi-Fi specifications the Wi-Fi terminal is named STA), should move to WLAN, and to control whether all or only some of the UEs in the system should move. In some embodiments, the procedure contains a notification message sent by the UE that notifies the NW that that it has discovered one or more suitable WLAN access points. Whether a particular access point is suitable or not can be based on whether the UE measures enough received signal strength and signal quality, for example. Other criteria for identifying suitable WLAN access points may include other information elements and policies (such as service set identification (SSID) and/or public land mobile network (PLMN)) that have been received by the UE from the network and/or stored in the terminal (e.g. on a SIM card).

In some embodiments, the network sends a measurement configuration (alternatively referred to herein as a “reporting configuration” message) defining, e.g., the radio measurements to be performed and/or which events should trigger a notification message from the UE to the network. The network subsequently receives a notification message (alternatively referred to herein as a “terminal report”) from the UE. The notification message/terminal report may be very simple, in some embodiments, indicating that at least one AP has met certain requirements. In other embodiments, the notification message may contain more information, such as which APs (identified by AP identifiers included in the notification message) or AP are available to the terminal, measurement data that the terminal has available, and/or any other information that may be valid for the decision. The network then bases its decision as to whether to offload the UE or not based on the received information from the terminal. This decision may also be based on information and measurements taken and/or available on the network side, such as measurements of the network load, to decide whether the bearers (all or a few) supported by the UE should be moved to WLAN (in addition or alternatively, the decision can be to keep all or a few of the bearers supported by the UE in the 3GPP network). The decision made by the network whether to move the bearers or not is sent to the UE, e.g., in the form of a “traffic steering” message. The UE will then execute the decision. If the network decision is to not move any bearers or traffic to WLAN then no change is needed and hence there no need to send a message to move to WLAN.

Other embodiments of the presently disclosed techniques include techniques that, in a similar fashion, determine when to move traffic (bearers) from WLAN to 3GPP. In this case, the messages will go to/from other nodes in the network, e.g., to a node in the WLAN.

In some of these and in other embodiments, the 3GPP network node may also check the conditions in the WLAN AP in order to know whether the AP in the WLAN side has enough capacity and may provide better QoS. This information may be used in the decision as to whether to offload the UE's traffic, whether in whole or in part.

In still further embodiments, the 3GPP radio access network (RAN) can perform traffic steering for a UE, where the traffic steering takes into account one or more ANDSF policies in the UE. In some of these embodiments, the notification message sent from the UE to the RAN reflects the one or more ANDSF policies. For example, the notification message/terminal report may omit measurement information for WLAN access points that are not allowed to the mobile terminal per an ANDSF policy or rule. In some embodiments, the notification message/terminal report indicates to the RAN which WLAN access points are seen by the terminal but are not allowed, per an ANDSF policy. In some of these embodiments, the notification message/terminal report includes measurement data for these non-allowed access points, while in others the measurement data for non-allowed access points is omitted.

In alternative (and in some cases preferred) embodiments to those described above, the UE may not be required to respond with a terminal report when the criteria in the reporting configuration message are fulfilled, and instead the UE can be allowed to offload to the WLAN (if also permitted to do so by an ANDSF policy, if appropriate) as soon as the criteria in the reporting configuration message are fulfilled.

According to a first specific embodiment, there is provided a method of operating a terminal in a first network that is operating according to a first radio access technology, RAT, the method comprising receiving a message from the first network, the message being for configuring the terminal with a set of criteria for enabling, detecting and/or performing measurements over a second RAT; determining if the set of criteria in the message are fulfilled by a network operating according to a second RAT; and steering all or a subset of the traffic for the terminal to the network operating according to the second RAT if the set of criteria are fulfilled.

In some embodiments the step of determining if the set of criteria in the message are fulfilled comprises performing measurements of a network operating according to a second RAT and comparing the measurements to the set of criteria in the message.

In some embodiments the method further comprises the steps of evaluating an Access Network Discovery and Selection Function, ANDSF, policy; and determining whether to steer all or a subset of the traffic for the terminal to a network operating according to the second RAT using the measurements and the result of the evaluation of the ANDSF policy.

In some embodiments the ANDSF policy indicates one or more networks operating according to the second RAT and/or one or more nodes in a network operating according to the second RAT that the terminal should not connect to.

In some embodiments the set of criteria comprises one or more of a 3GPP received signal strength, a wireless local area network, WLAN, received signal strength, a 3GPP received signal quality, a WLAN received signal quality, a 3GPP load and a WLAN load.

In some embodiments the method further comprises the step of receiving from the first network information on limitations to which frequencies are to be scanned and/or information as to limitations of valid wireless local area networks, WLANs, and/or WLAN access points, APs.

In some embodiments the information on limitations to which frequencies are to be scanned and/or information as to limitations of valid WLANs, and/or WLAN APs is received from the first network in the message.

In some embodiments the message received from the first network further comprises a set of criteria for enabling, detecting, and/or performing measurements over the first RAT once the terminal has steered all or a subset of its traffic to a network operating according to the second RAT.

In some embodiments the first RAT is a cellular RAT and the network operating according to the second RAT is a wireless local area network. In some embodiments the first RAT is a Universal Mobile Telecommunications System, UMTS, or Long Term Evolution, LTE, system. In some embodiments the network operating according to the second RAT is an IEEE 802.11 network.

According to a second aspect, there is provided a terminal for use in a first network that is operating according to a first radio access technology, RAT, the terminal comprising a transceiver unit for communicating with two or more types of radio access network; and a processing circuit adapted to receive a message from the first network, the message being for configuring the terminal with a set of criteria for enabling, detecting and/or performing measurements over a second RAT; determine if the set of criteria in the message are fulfilled by a network operating according to a second RAT; and steer all or a subset of the traffic for the terminal to the network operating according to the second RAT if the set of criteria are fulfilled.

Various embodiments of the terminal are also contemplated in which the processing circuit is configured to implement the embodiments of the method of operating a terminal described above.

According to a third aspect, there is provided a method of allowing a first network that is operating according to a first radio access technology, RAT, to determine when a terminal should associate to a second network that is operating according to a second RAT, the method in the first network comprising sending a message to the terminal, the message being for configuring the terminal with a set of criteria for enabling, detecting and/or performing measurements over the second RAT.

In some embodiments the set of criteria comprises one or more of a 3GPP received signal strength, a wireless local area network, WLAN, received signal strength, a 3GPP received signal quality, a WLAN received signal quality, a 3GPP load and a WLAN load.

In some embodiments the method further comprises the step of sending information to the terminal on limitations to which frequencies are to be scanned and/or information as to limitations of valid wireless local area networks, WLANs, and/or WLAN access points, APs.

In some embodiments the information on limitations to which frequencies are to be scanned and/or information as to limitations of valid WLANs, and/or WLAN APs is sent to the terminal in the message.

In some embodiments the set of criteria in the message sent to the terminal comprise one or more thresholds, and wherein the first network sets the one or more thresholds in the message based on load in the first network.

In some embodiments the step of sending a message to the terminal comprises broadcasting or unicasting the message to the terminal.

In some embodiments the first RAT is a cellular RAT and the network operating according to the second RAT is a wireless local area network. In some embodiments the first RAT is a Universal Mobile Telecommunications System, UMTS, or Long Term Evolution, LTE, system. In some embodiments the network operating according to the second RAT is an IEEE 802.11 network.

In some embodiments the message sent to the terminal further comprises a set of criteria for the terminal for enabling, detecting, and/or performing measurements over the first RAT once the terminal has steered all or a subset of its traffic to the network operating according to the second RAT.

In some embodiments the message further comprises an indication that the terminal is to steer all or a subset of its traffic to the network operating according to the second RAT if the set of criteria in the message is fulfilled.

In other embodiments the method further comprises the steps of receiving a report from the terminal when the criteria in the message have been fulfilled; and sending a message to the terminal, the message comprising an indicator that the terminal should steer all or a subset of its traffic to the network operating according to the second RAT.

In some embodiments the report received from the terminal comprises an indication that at least one node in a network operating according to a second RAT has met the criteria for the terminal.

In some embodiments the report received from the terminal comprises an indication of the result of the evaluation of an Access Network Discovery and Selection Function, ANDSF, policy by the terminal.

In some embodiments the method further comprises the step of determining whether the terminal should steer all or a subset of its traffic to the network operating according to the second RAT based on the received report.

In some embodiments the step of sending a message to the terminal, with the message comprising an indicator that the terminal should steer all or a subset of its traffic to the network operating according to the second RAT, is performed if it is determined that the terminal should steer all or a subset of its traffic to a network operating according to the second RAT; and wherein if it is determined that the terminal should not steer any traffic to a network operating according to the second RAT, the method further comprises the step of sending a message to the terminal, the message comprising an indicator that the terminal should not steer any traffic to a network operating according to the second RAT.

In some embodiments the method further comprises the steps of receiving information on the load in the first network and/or the load in a network operating according to the second RAT; and determining whether the terminal should steer all or a subset of its traffic to the network operating according to the second RAT based on the received report and the received load information.

In some embodiments the message comprising an indicator that the terminal should steer all or a subset of its traffic to the network operating according to the second RAT identifies one or more bearers to be steered to the network operating according to the second RAT or to be kept in the first network.

In some embodiments the message comprising an indicator that the terminal should steer all or a subset of its traffic to the network operating according to the second RAT identifies a particular node in a network operating according to the second RAT that the traffic should be steered to.

In some embodiments the method is performed in a network node. In some embodiments the network node is a base station, a Radio Network Controller, a NodeB, or an enhanced NodeB.

According to a fourth aspect, there is provided a network node for use in a first radio access network operating according to a first radio access technology, RAT, the network node comprising a radio transceiver for communicating with one or more terminals; and a processing circuit adapted to send a message to a terminal, the message being for configuring the terminal with a set of criteria for enabling, detecting and/or performing measurements over a network operating according to a second RAT.

Various embodiments of the network node are also contemplated in which the network node is configured to implement the embodiments of the method in the first network described above.

According to a fifth aspect, there is provided a method of operating a terminal in a first network that is operating according to a first radio access technology, RAT, the method comprising receiving a message from the first network, the message being for configuring the terminal with a set of criteria for enabling, detecting and/or performing measurements over a network operating according to a second RAT; sending a report to the first network when the criteria in the message have been fulfilled; and receiving a message from the first network, the message comprising an indicator that the terminal should steer all or a subset of its traffic to a network operating according to the second RAT.

In some embodiments the method further comprises the steps of evaluating an Access Network Discovery and Selection Function, ANDSF, policy; and indicating a result of the evaluation of the ANDSF policy in the report sent to the first network when the criteria in the received message have been fulfilled.

In some embodiments the ANDSF policy indicates one or more networks operating according to the second RAT and/or one or more nodes in a network operating according to the second RAT that the terminal should not to connect to.

In some embodiments the set of criteria comprises one or more of a 3GPP received signal strength, a wireless local area network, WLAN, received signal strength, a 3GPP received signal quality, a WLAN received signal quality, a 3GPP load and a WLAN load.

In some embodiments the message received from the first network comprises limitations to which frequencies are to be scanned, information as to limitations of valid wireless local area networks, WLANs, and/or WLAN access points, APs.

In some embodiments the message received from the first network further comprises a set of criteria for enabling, detecting, and/or performing measurements over a network operating according to the first RAT once the terminal has steered all or a subset of its traffic to a network operating according to the second RAT.

In some embodiments the first RAT is a cellular RAT and the network operating according to the second RAT is a wireless local area network. In some embodiments the first RAT is a Universal Mobile Telecommunications System, UMTS, or Long Term Evolution, LTE, system. In some embodiments the network operating according to the second RAT is an IEEE 802.11 network.

In some embodiments the report sent to the first network comprises an indication that at least one node in a network operating according to a second RAT has met the criteria.

In some embodiments the method further comprises the step of steering all or a subset of the terminal's traffic to the network operating according to the second RAT if the set of criteria in the received message are fulfilled.

In some embodiments the message comprising an indicator that the terminal should steer all or a subset of its traffic to the network operating according to the second RAT identifies one or more bearers to be steered to the network operating according to the second RAT or to be kept in the first network.

In some embodiments the message comprising an indicator that the terminal should steer all or a subset of its traffic to a network operating according to the second RAT identifies a particular node in a network operating according to the second RAT that the traffic should be steered to.

In some embodiments the method further comprises the step of performing measurements of a network operating according to a second RAT using the set of criteria in the message.

According to a sixth aspect, there is provided a terminal for use in a first network that is operating according to a first radio access technology, RAT, the terminal comprising a transceiver unit for communicating with two or more types of radio access network; and a processing circuit adapted to receive a message from the first network, the message being for configuring the terminal with a set of criteria for enabling, detecting and/or performing measurements over a network operating according to a second RAT; send a report to the first network when the criteria in the message have been fulfilled; and receive a message from the first network, the message comprising an indicator that the terminal should steer all or a subset of its traffic to a network operating according to the second RAT.

Various embodiments of the terminal are also contemplated in which the processing circuit is configured to implement the embodiments of the method of operating a terminal described above.

According to a seventh aspect, there is provided a computer program product having computer readable code embodied therein, the computer readable code being configured such that, on execution by a suitable processor or computer, the processor or computer performs any of methods described above.

According to an eighth aspect, there is provided a method of allowing a first network that is operating according to a first radio access technology, RAT, to determine when a terminal should associate to a second network that is operating according to a second RAT, the method in the first network comprising sending a message to the terminal, the message being for configuring the terminal with a set of criteria for enabling, detecting or performing measurements over the second RAT; receiving a report from the terminal when the criteria in the message have been fulfilled; and sending a message to the terminal, the message comprising an indicator that the terminal should steer all or a subset of its traffic to the second RAT.

### BRIEF DESCRIPTION OF THE DRAWINGS

Features, objects and advantages of the presently disclosed techniques will become apparent to those skilled in the art by reading the following detailed description where references will be made to the appended figures in which:

FIGS. 1 and 2 show a simplified architecture of a W-Fi network;

FIG. 3 is an illustration of a simplified ANDSF architecture;

FIGS. 4 and 5 illustrate BSS load and WAN metrics elements;

FIG. 6 illustrates a W-Fi network that is not integrated into a mobile network;

FIG. 7 illustrates some of the drawbacks of a Wi-Fi-if-coverage strategy method of access network selection;

FIG. 8 is an illustration of integration of Wi-Fi and a mobile cellular network using common authentication;

FIG. 9 is an illustration of user plane integration of Wi-Fi and a mobile cellular network;

FIG. 10 is an architectural overview of E-UTRAN/EPC and S2a integration;

FIG. 11 is an illustration of the different deployment scenarios for W-Fi;

FIG. 12 is a diagram illustrating the overall architecture of an LTE network;

FIG. 13 is a diagram illustrating the functional split between E-UTRAN and EPC;

FIG. 14 illustrates part of a LTE network and a W-Fi network;

FIG. 15 is a diagram illustrating the signalling according to a first set of embodiments;

FIG. 16 is a flow chart illustrating a method of operating a network node according to the first set of embodiments;

FIG. 17 is a flow chart illustrating a method of operating a terminal according to the first set of embodiments;

FIG. 18 is a flow chart illustrating an alternative method of operating a network node according to the first set of embodiments;

FIG. 19 is a flow chart illustrating an alternative method of operating a terminal according to the first set of embodiments;

FIG. 20 is a diagram illustrating the signalling according to a second set of embodiments;

FIG. 21 is a flow chart illustrating a method of operating a network node according to the second set of embodiments;

FIG. 22 is a flow chart illustrating a method of operating a terminal according to the second set of embodiments;

FIG. 23 is a block diagram of an exemplary terminal according to several embodiments; and

FIG. 24 is a block diagram of an exemplary node according to several embodiments.

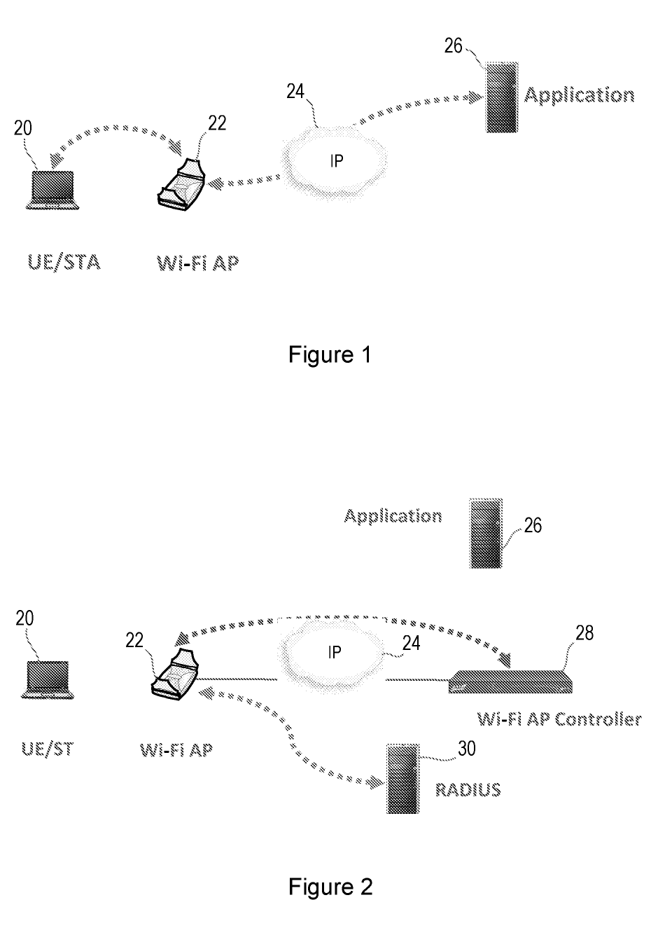

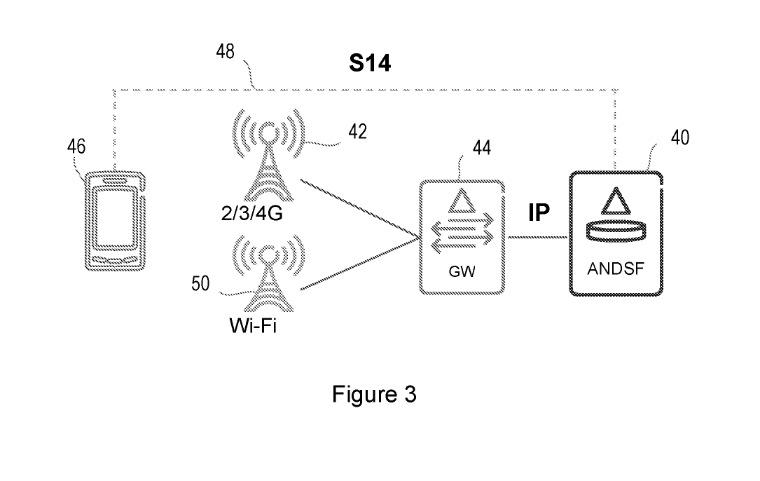

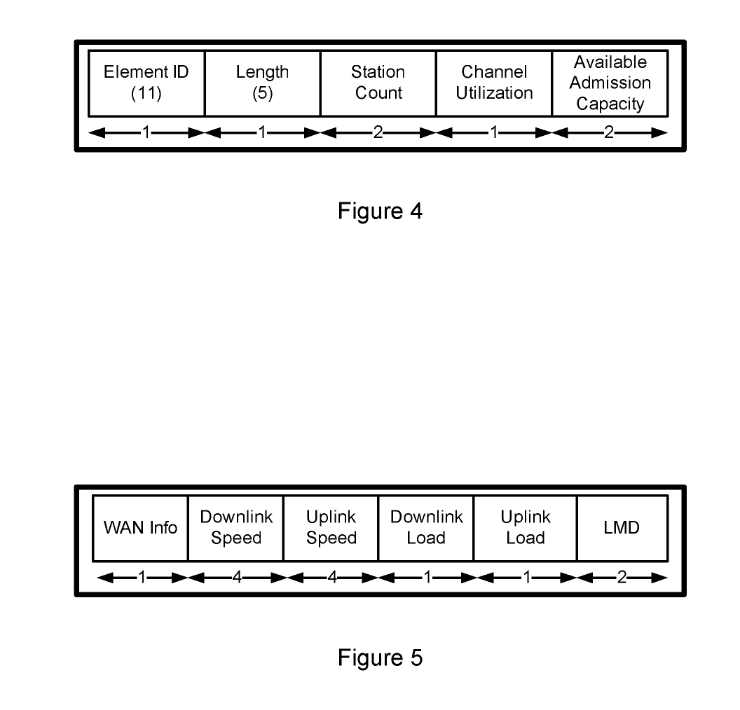

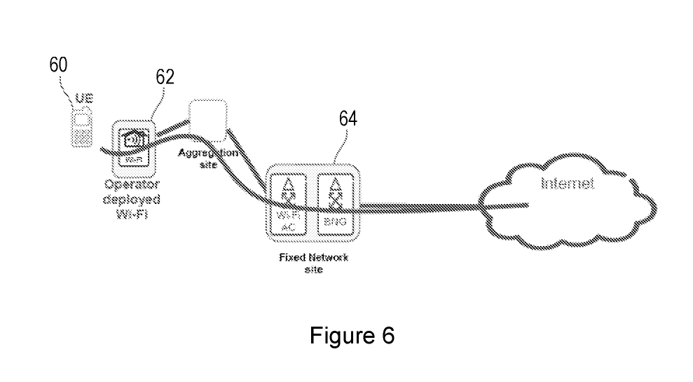

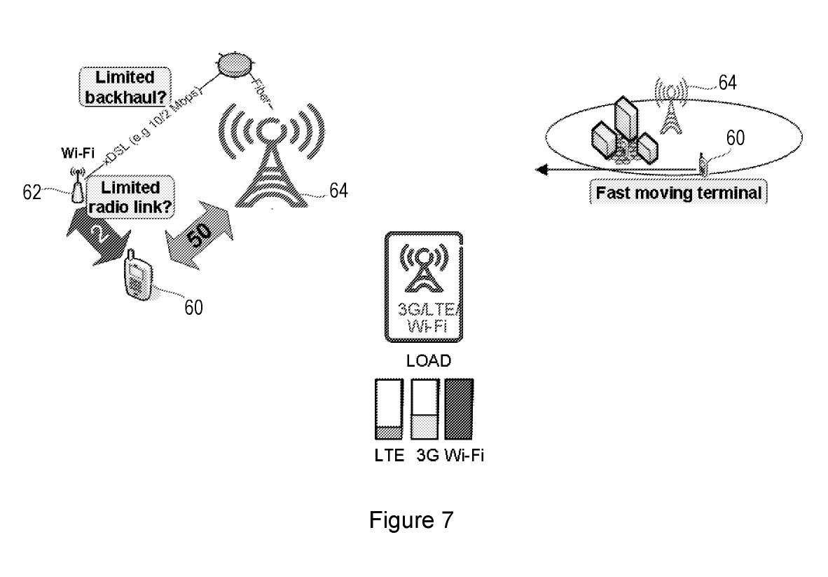

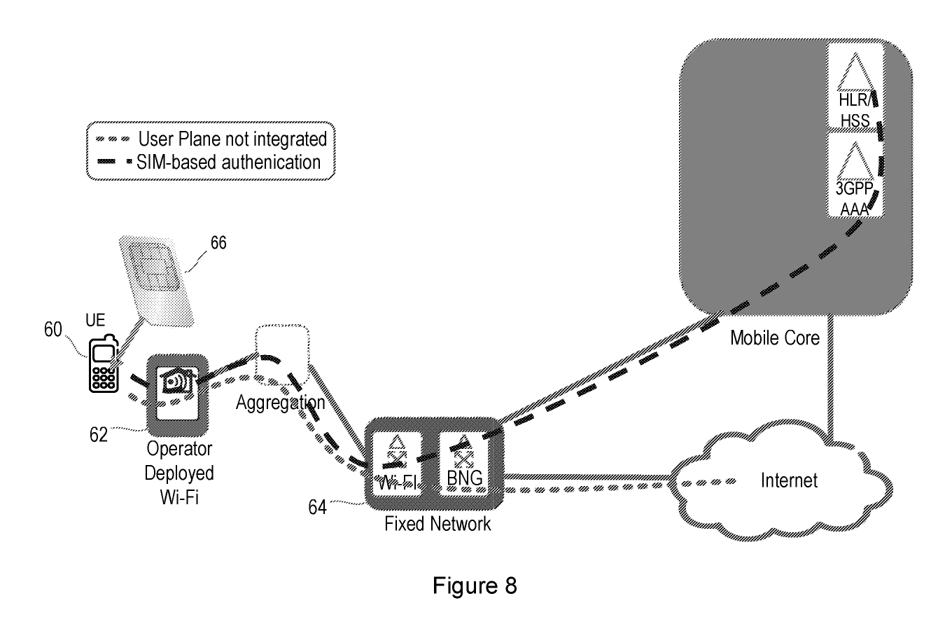

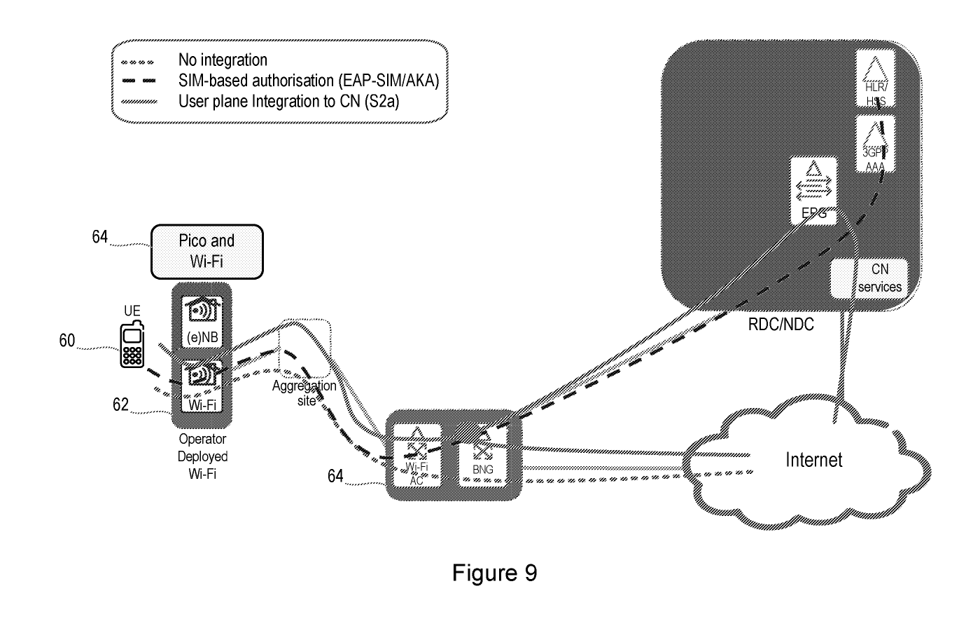

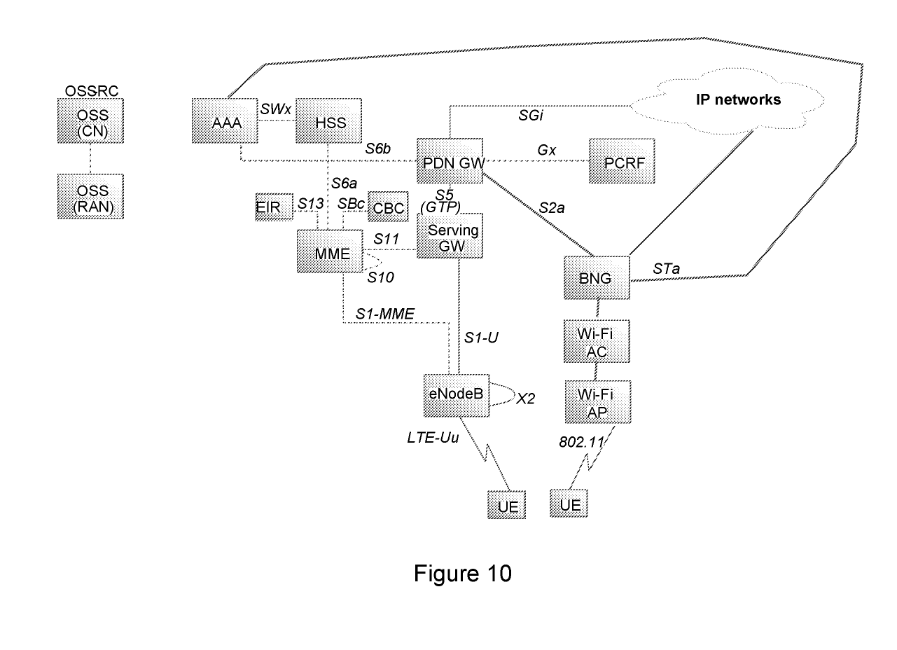

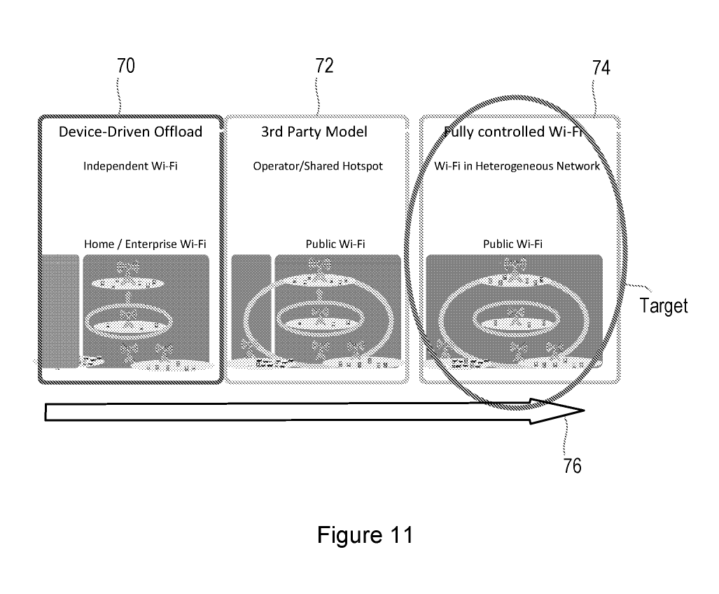

### DETAILED DESCRIPTION

In the discussion that follows, specific details of particular embodiments of the present invention are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not obscure the description with unnecessary detail. Those skilled in the art will appreciate that the functions described may be implemented in one or in several nodes. Some or all of the functions described may be implemented using hardware circuitry, such as analog and/or discrete logic gates interconnected to perform a specialized function, application-specific integrated circuits (ASICs), programmable logic arrays (PLAs), digital signal processors (DSPs), reduced instruction set processors, field programmable gate arrays (FPGAs), state machines capable of performing such functions, etc. Likewise, some or all of the functions may be implemented using software programs and data in conjunction with one or more digital microprocessors or general purpose computers. Where nodes that communicate using the air interface are described, it will be appreciated that those nodes also have suitable radio communications circuitry. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations of the present invention may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The discussion that follows frequently refers to “terminals”, “mobile devices”, “mobile stations” or “UEs,” which is a 3GPP term for end user wireless devices. It should be appreciated, however, that the techniques and apparatus described herein are not limited to 3GPP UEs, but are more generally applicable to end user wireless devices (e.g., portable cellular telephones, smartphones, wireless-enabled tablet computers, etc.) that are useable in cellular systems and that are capable of communicating with a radio access network (RAN) using multiple carriers or cells (e.g. known as a carrier aggregation (CA) mode in LTE). It should also be noted that the current disclosure relates to end user wireless devices that support both a wide-area cellular technology, such as any of the wide-area radio access standards maintained by 3GPP, and a wireless local area network (WLAN) technology, such as one or more of the IEEE 802.11 standards. End user devices are referred to in Wi-Fi document as “stations,” or “STA”—it should be appreciated that the term “UE” as used herein should be understood to refer to a STA, and vice-versa, unless the context clearly indicates otherwise. It should also be noted that the current disclosure also relates to end user wireless devices that support both a wide-area cellular technology, such as any of the wide-area radio access standards maintained by 3GPP, and a non-3GPP standardized RAT, for which improvements to the selection of the access network are desired.

As used herein, a “base station” comprises in a general sense any node transmitting radio signals in the downlink (DL) to a mobile device and/or receiving radio signals in the uplink (UL) from the mobile device. Some example base stations are eNodeB, eNB, Node B, macro/micro/pico/femto radio base station, home eNodeB (also known as femto base station), relay, repeater, sensor, transmitting-only radio nodes or receiving-only radio nodes. A base station may operate or at least perform measurements in one or more frequencies, carrier frequencies or frequency bands and may itself be capable of carrier aggregation. It may also be a single-radio access technology (RAT), multi-RAT, or multi-standard node, e.g., using the same or different base band modules for different RATs. Although the embodiments described below refer to a macrocell base station, it will be appreciated that the teachings of this application are applicable to any type of base station (e.g. femtocell base stations, picocell base stations, microcell base station, etc.) whether deployed in a homogeneous or heterogeneous network.

The signalling described is either via direct links or logical links (e.g. via higher layer protocols and/or via one or more network nodes). For example, signalling from a coordinating node may pass another network node, e.g., a radio node.

### Overall E-UTRAN Architecture

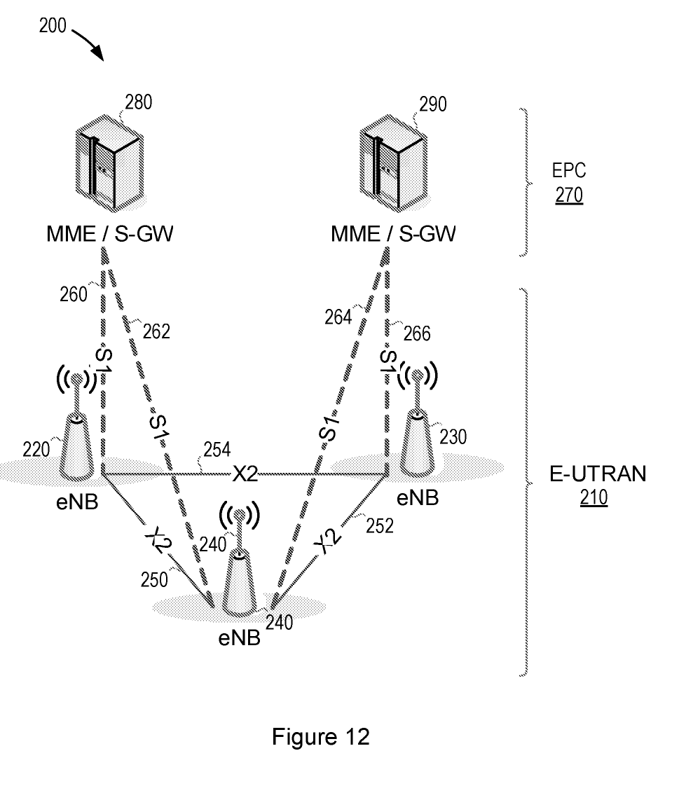

An exemplary Evolved UMTS (Universal Mobile Telecommunications System) Terrestrial Radio Access Network (E-UTRAN) architecture is shown in FIG. 12. The E-UTRAN architecture 210 consists of base stations 220, 230, 240 called enhanced NodeBs (eNBs or eNodeBs), which provide the E-UTRA user plane and control plane protocol terminations towards the User Equipment (UE). The eNBs 220, 230, 240 are interconnected with each other by means of the X2 interface 6. The eNBs 220, 230, 240 are also connected by means of the S1 interface 260, 262, 264, 266 to the EPC 270 (Evolved Packet Core), more specifically to the MME 280, 290 (Mobility Management Entity), by means of the S1-MME interface, and to the Serving Gateway 280, 290 (S-GW) by means of the S1-U interface. The S1 interface supports many-to-many relations between MMEs/S-GWs and eNBs.

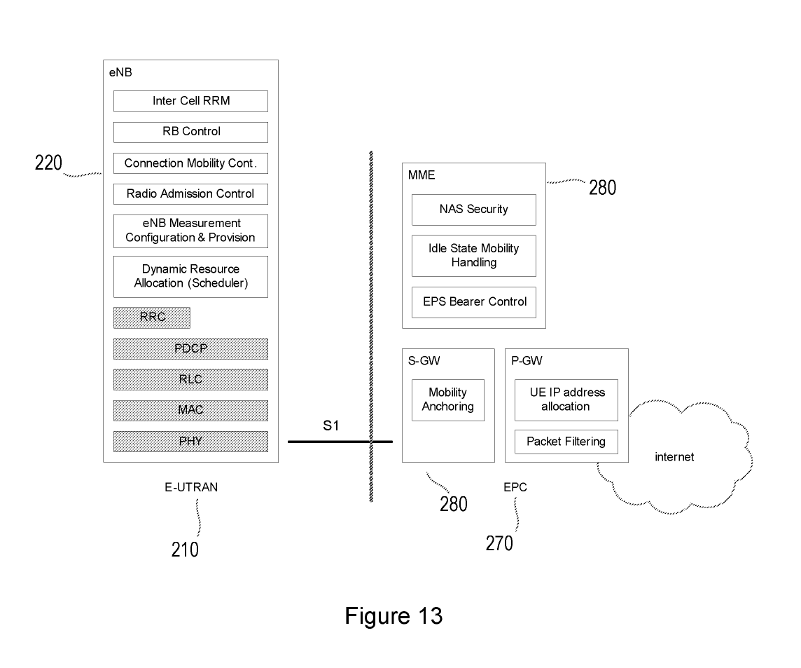

The eNB 220, 230, 240 hosts functionalities such as Radio Resource Management (RRM), radio bearer control, admission control, header compression of user plane data towards serving gateway, and routing of user plane data towards the serving gateway. The MME 280, 290 is the control node that processes the signalling between the UE and the core network 270. The main functions of the MME 280, 290 are related to connection management and bearer management, which are handled via Non Access Stratum (NAS) protocols. The S-GW 280, 290 is the anchor point for UE mobility, and also includes other functionalities such as temporary downlink data buffering while the UE is being paged, packet routing and forwarding the right eNB 220, 230, 240, gathering of information for charging and lawful interception. The PDN (Packet Data Network) Gateway (P-GW—not shown in FIG. 12) is the node responsible for UE IP address allocation, as well as Quality of Service (QoS) enforcement. FIG. 13 gives a summary of the functionalities of the different nodes, and the 3GPP document “Evolved Universal Terrestrial Radio Access (E-UTRA) and Evolved Universal Terrestrial Radio Access Network (E-UTRAN); Overall Description; Stage 2,” 3GPP TS 36.300, v. 11.3.0 (September 2012), available at www.3gpp.org, and the references therein provides the details of the functionalities of the different nodes. In FIG. 13, the boxes labelled “eNB,” “MME,” “S-GW,” and “P-GW” depict the logical nodes, the unshaded boxes within the larger boxes depict the functional entities of the control plane, and the shaded boxes within the box labelled “eNB” depict the radio protocol layers.

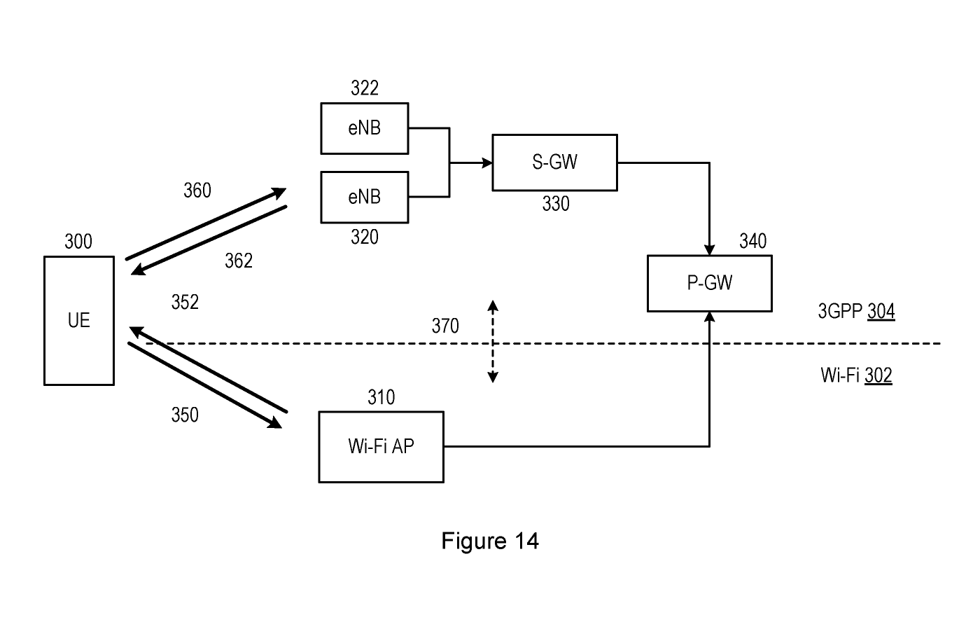

FIG. 14 illustrates a network where the LTE radio access parts (eNBs) 320, 322 and a Wi-Fi wireless access point 310 are both connected to the same P-GW 340. In the case of the LTE radio access parts, the eNBs 320, 322 are connected to the P-GW 340 via an S-GW 330. A UE 300 is shown that is capable of being served both from the Wi-Fi Access Point 310 and the LTE eNBs 320, 322. Arrows 350 and 352 illustrate the uplink (UL) and downlink (DL) transmissions between the UE 300 and the Wi-Fi AP 310 respectively and arrows 360 and 362 illustrate the uplink (UL) and downlink (DL) transmissions between the UE 300 and the eNBs respectively. FIG. 14 illustrates one possible way of connecting a Wi-Fi access network 302 to the same core network as the 3GPP-specified access network 304. It should be noted that the presently disclosed techniques are not restricted to scenarios where the Wi-Fi access network 302 is connected in this way; scenarios where the networks are more or completely separate, such as shown in FIG. 5, 7, 8, 9 or 10 are also possible.

In the following description of the various solutions provided by the present disclosure, the arrangement shown in FIG. 14 is used as a basis for the explanation, and references in the description below to a terminal/UE, eNB, 3GPP network/RAN/RAT, Wi-Fi AP and WLAN are to the UE 300, eNB 320, 3GPP network/RAN/RAT 304, Wi-Fi AP 310 and WLAN 302 shown in FIG. 14. However, it will be appreciated that the various solutions provided by the present disclosure are not limited to implementation in the arrangement shown in FIG. 14.

Some embodiments of the currently disclosed techniques address scenarios where a terminal is moving around in an area in which there is both Wi-Fi Access point (AP) coverage and 3GPP RAT coverage (currently, one of GSM, HSPA, UMTS/WCDMA, or LTE or any extensions thereof).

According to a first set of embodiments, three messages and some associated procedures are provided, allowing a first RAT (i.e. a first network operating according to a first RAT) to determine when a terminal should associate to a second RAT (e.g. a second network operating according to a second, different, RAT). The first message (see the section entitled ‘Message 1—Reporting configuration’ below) is sent from the network to the terminal and configures the terminal with a set of criteria for enabling, detecting, and/or performing measurements over (i.e. related to) the second RAT. The terminal sends a report, message 2 (see the section entitled ‘Message 2—Terminal Report’ below), to the network when the criteria given in the first message have been fulfilled. The third message (see the section entitled ‘Message 3—Traffic steering message’ below) is an indicator sent from the network to the terminal that the terminal should steer all or a subset of its traffic to the second RAT.

It will be appreciated by those skilled in the art that, unless the context clearly indicates otherwise, references in the explanation below to “3GPP RAT”, “WLAN RAT” and “Wi-Fi RAT” are to access networks (e.g. RANs) operating according to those radio access technologies (with “first RAT” and “second RAT” being interpreted in a similar way). In a similar manner, it will be understood by those skilled in the art that references in the explanation below to operations being performed by a RAT (e.g. the transmission of a reporting configuration message, the transmission of traffic steering commands, the steering of traffic to the RAT, etc.) are to those operations being performed by a network operating according to the RAT.

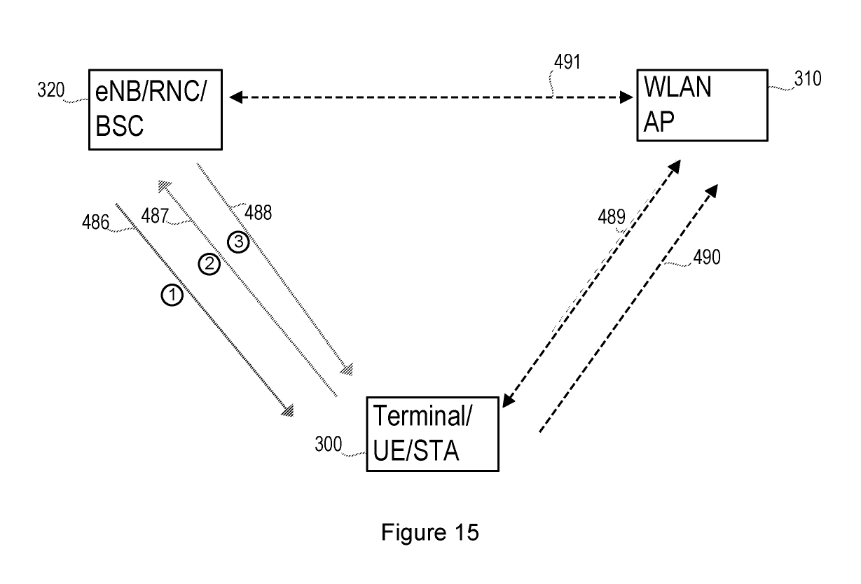

FIG. 15 illustrates the involved signalling for enabling several of the first set of embodiments of the techniques, apparatus and systems disclosed herein. Note that in some embodiments, the 3GPP radio access network (RAN) is in control of the mechanisms described below, i.e., the 3GPP RAN decides when message 1 and message 3 should be sent, and indirectly determines when message 2 should be sent through the criteria specified in message 1 and with which contents. However, the 3GPP RAN may not know policies maintained in the UE that are set by ANDSF, since ANDSF is usually handled on a core-network level.

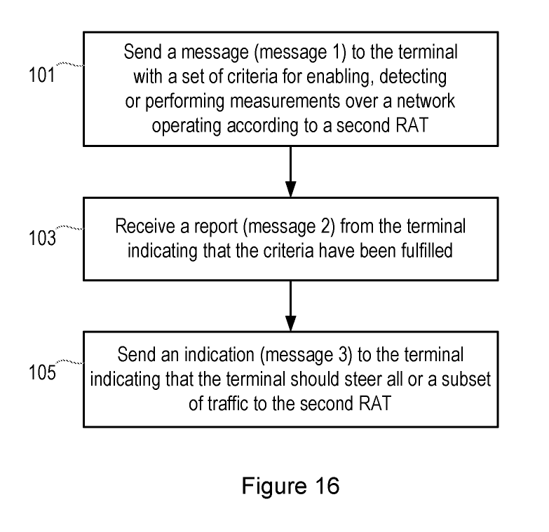

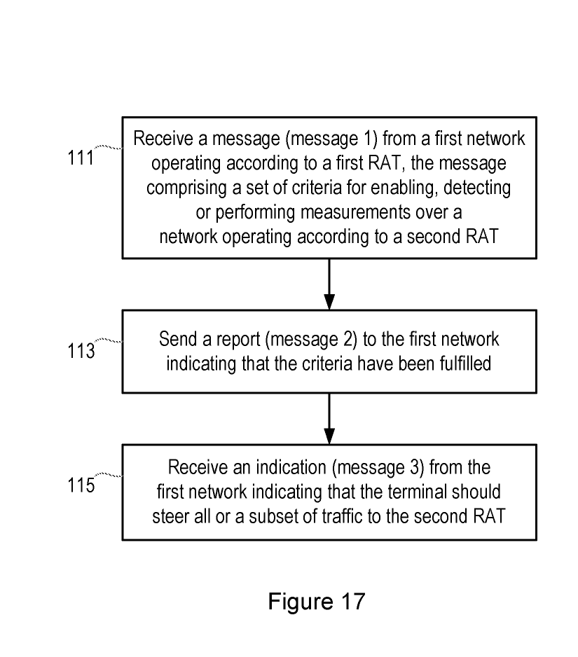

Thus, FIG. 15 illustrates the signalling between a node in a first network, such as a wide area network (e.g. 3GPP) node 320, such as an eNB, RNC or BSC (as appropriate for the RAT used in the wide area network), a terminal 300 (such as a UE, STA or mobile device) and a node in a second network, such as a WLAN access point 310 according to several embodiments of the techniques, apparatus and systems disclosed herein. It should be noted that the components 320 and 310 in FIG. 15 are also referred to more generally as the 3GPP network 304 and WLAN 302 below (although of course it will be appreciated that a 3GPP network and/or WLAN will comprise other nodes/entities than those illustrated in FIG. 15). The flow charts in FIGS. 16 and 17 illustrate methods of operating a network node and terminal respectively according to the first set of embodiments.

In a first step of FIG. 16 (step 101), the node 320 in the first network sends a message 486 (message 1) to the terminal 300 with the message indicating a set of criteria for enabling, detecting, and/or performing measurements over the second RAT (the WLAN in this illustrated embodiment, although it will be appreciated that the criteria can be used for enabling, detecting, and/or performing measurements over multiple networks that operate according to the second RAT, e.g. multiple WLANs). This message is received by the terminal (step 111 of FIG. 17).

The terminal 300 determines if the set of criteria in the received message are fulfilled (for example by performing the required measurements of the second RAT and comparing them to the criteria in the received message, or by comparing measurements made prior to receipt of the reporting configuration message 486), and if the set of criteria in the received message are fulfilled, the terminal 300 sends a terminal report 487 (message 2) to the network node 320 indicating this (step 113).

The network node 320 receives this terminal report (step 103), and considers the terminal report 487 when determining whether to generate and send (step 105) a traffic steering message 488 (message 3) to the terminal 300 to instruct or cause the terminal 300 to steer all or a subset of traffic (e.g. only voice, only data, only a subset of data, etc.) to the second RAT (e.g. the WLAN 302).

The terminal 300 receives this traffic steering message 488 (message 3) in step 115 and acts accordingly to steer all or a subset of traffic to a network 302 operating according to the second RAT, e.g. WLAN 302 (indicated by dashed arrow 489).

The three messages used in the above embodiments are discussed in more detail in the sections below.

It will be appreciated that in some cases the terminal 300 may have performed the measurements prior to the reception of message 1.

### Message 1—Reporting Configuration

The first message under discussion, labelled “1” (signal 486) in FIG. 15, is transmitted from the network to the terminal and configures the terminal with a set of criteria for enabling, detecting, and/or performing measurements over (i.e. related to) the second RAT. This message may be referred to as a “reporting configuration message” in the discussion that follows. It will be appreciated from the following discussion that not all criteria or parameters in the reporting configuration message 486 have to relate to measurements to be performed on the second RAT, and some of the criteria or parameters may relate to measurements to be performed (and/or measurements already ongoing) on the first RAT (and in particular on the network operating according to the first RAT that the UE 300 is associated with).

The content of this first message is a set of criteria. The criteria could be that a certain parameter should exceed or fall below a given threshold. These parameters may include one or more of a 3GPP received signal strength, a WLAN received signal strength, a 3GPP received signal quality, a WLAN received signal quality, a 3GPP related load, a WLAN related load, etc.

One possible set of criteria which is contained in one possible reporting configuration message is as follows:
Received signal strength larger than threshold x
Received signal quality larger than threshold y
WLAN load less than threshold z

Load could be defined and quantified in different ways. Load could be, for example, a function of utilization of radio resources, utilization of the backhaul link of the 3GPP base station 320/WLAN AP 310, processing load of a node in the network, etc. It is not important exactly how load is defined, for the purposes of understanding the presently disclosed techniques. In WLAN, the load could be the BSS load broadcast in the beacon signal signifying the utilization of the AP and number of associated user; the WAN metric info signifying the utilization and capacity of the backhaul link, or a combination of the BSS load and WAN metric. The terminal 300 might be able to determine some other load information about the WLAN by sensing the medium.

In some embodiments, less than the whole set of possible criteria are sent, i.e. one or more criteria may be sent. There could also be information sent about limitations to which frequencies to be scanned, and/or other information as limitations of valid APs and/or WLAN networks. There could also be a time-to-trigger duration which tells the terminal the duration of time during which the criteria need to be fulfilled for the terminal to trigger the sending of a terminal report message 487.

The triggers for the network to send the reporting configuration 486 may be based on the state of the network, in some embodiments. For example, when the 3GPP network is heavily loaded, it is desired to offload some of the terminals/traffic to WLAN. Accordingly, the 3GPP network can adjust the signalled thresholds according to the urgency of offloading terminals. If the network load is high the thresholds can be set in such a way that increases the probability for a terminal 300 to find the criteria in the reporting configuration message 486 met and to send a terminal report message 487, while if the network load is low the thresholds can be set to reduce the probability of the terminal 300 finding the criteria in the reporting configuration message 486 to be met. For this reason, the 3GPP network 304 may resend the message 486 but possibly with different content/values.

The reporting configuration message 486 may be broadcasted in the network 304. The benefit of broadcasting it is that signalling to each UE 300 is not needed and hence unnecessary signalling load is avoided. The network 304 may broadcast more than one reporting configuration message 486, such that different terminals 300 read different messages. This could be used to achieve differentiated terminal behaviour. For example a set of “gold terminals” may be configured to read one reporting configuration message 487 while a set of “silver terminals” is configured to read another reporting configuration message 487. Another advantage of broadcasting the configuration is that even IDLE terminals 300 in 3GPP 304 can be able to receive the configuration as they can read some of the broadcasted information.

Another alternative for sending the reporting configuration message 486 is to unicast it. Unicasting this message has the benefit that different terminals 300 can receive different configurations. This can, for example, be used to selectively give to a UE 300 with high traffic volume a configuration that increases its probability of sending a terminal report message 487 (thereby increasing the probability that it will be offloaded towards WLAN 302) in case the 3GPP network 304 is being overloaded. Similarly, a UE that is generating low traffic UE may be sent a configuration with which it less likely will generate a terminal report.

In some embodiments, if a terminal 300 has not received a unicasted, dedicated reporting configuration message 486, it may apply the broadcasted reporting configuration message 486, if available. This behaviour will allow the network 304 to only send a unicasted reporting configuration message 486 to those UEs 300 which should not use the broadcasted reporting configuration message 486 and the number of reporting configuration message transmissions can be reduced. In case a terminal 300 has received a unicasted reporting configuration message 486 it will according to this behaviour not apply the broadcasted reporting configuration message 486. Therefore there may be a special indicator sent to the UE 300 (that may be broadcasted or unicasted), which indicates to the UE 300 that, even though it has received a unicasted reporting configuration message 486, it should apply the broadcasted reporting configuration message 486.

Alternatively, some configurations can be sent over in a broadcast fashion and are applicable to all UEs, and additional configurations can be sent in a unicast manner to a UE that complement the broadcasted configurations. For example, the broadcasted configuration could contain a simple reference signal received power (RSRP) threshold, and if UEs detect that the measured RSRP of the serving cell falls below this threshold, they start measuring/scanning WLAN networks. A dedicated configuration could be for a certain UE to report back with message 2 (the terminal report 487) if the received signal strength indication (RSSI) of APs with SSID x becomes greater than X, while that for another UE could be to report back with message 2 if the RSSI of APs with SSID x or y becomes greater than Z.

When the terminal 300 has received a reporting configuration message 486 it should monitor the parameters associated with the criteria indicated in reporting configuration message. It will be appreciated that monitoring the parameters can comprise monitoring the parameters for multiple networks operating according to the second RAT (e.g. multiple WLANs, each with respective SSIDs and/or operated by different operators), as well as the network operating according to the first RAT (e.g. 3GPP network 304) in the case that the criteria in the reporting configuration message 486 comprises one or more criteria relating to the first RAT. In case the criteria are fulfilled the terminal 300 should send a terminal report 487 to the network 304.

In some embodiments, if no specific event criteria has been sent, or, e.g., if some essential criteria have not been sent by the network, the terminal 300 may be configured to use some default event criteria, such as to send message 2 (the terminal report 487) when a signal from an AP can be received and decoded. The reporting configuration message 486 may also contain an order in which to scan for WLANs 302. One likely implementation is that the network operator wants to prioritize the operator's own WLAN before other WLANs and the priority order could be set such that the terminal will scan for the operator's WLAN APs before other WLAN APs. The WLAN APs that the terminal 300 is allowed to connect to may have been sent to the terminal beforehand or stored in the terminal, e.g. on SIM-card. A list of WLAN APs that the terminal 300 is allowed to connect to may be received from the 3GPP RAN 304 or from an ANDSF server.

In one version of this embodiment a terminal 300 which has not received a reporting configuration message 486 will refrain from measuring WLAN. It may even turn off the WLAN radio (e.g. a transceiver unit in the terminal 300 that is configured to communicate with a WLAN) in such case in order to save power. The network can, with this behaviour, only send a reporting configuration message 486 to a terminal 300 when the network deems it necessary to offload this terminal to WLAN, and in case it is not necessary then the terminal 300 can save power by turning the WLAN radio off. Note that even though this mechanism has indicated that WLAN can be turned off the WLAN radio may still be turned on for other reasons, e.g. to scan for home-WLAN APs.

### Message 2—Terminal Report

The terminal report 487 is a message sent from the terminal 300 to the 3GPP network 304 reporting the fulfillment of the conditions given in the reporting configuration message 486.

The content of the report 487 may include more information such as all or part of the measurements done in the terminal 300 of the WLAN APs 310, information available in the terminal 300 from the WLAN 302 such as load, etc. As mentioned above, a time to trigger value can be specified which indicates to the UE 300 for how long the criteria should be fulfilled before the UE reports back with the terminal report 487. In addition to that, the UE 300 can be configured also with some filtering/smoothing parameters that it can use when collecting measurements to ensure that decisions will not be made based on instantaneous values. For example, the UE 300 can be configured with a moving average filter over a given duration, and the filtered value will be the one that will be compared with the threshold specified in the reporting configuration message 486. The parameters for filtering could be included in the reporting configuration message 486 and applicable only to the associated criteria, or they can be generic and communicated to the UEs beforehand (either in a dedicated or broadcasted manner) and applicable to all reporting configuration messages thereafter.

In case there is a need for the 3GPP network 304 to identify a specific WLAN network 302 and associated measurements made by the UE 300, WLAN identifiers (such as SSID, basic SSID (BSSID)) may be included in the terminal report 487. This information may be necessary if the 3GPP network 304 wants to move a terminal 300 to a specific WLAN network/AP/etc.

Example 1 below shows a terminal report according to one embodiment.

SSID = operatorX-WLAN7
Received signal strength = −73 dBm
Received signal quality = 4.2 dB
WLAN load = 47%
SSID = operatorX-WLAN2
Received signal strength = −82 dBm
Received signal quality = 2.5 dB
WLAN load = 47%
SSID = operatorX-WLAN5
Received signal strength = −96 dBm
Received signal quality = 1.4 dB
WLAN load = 49%

### Example 1

The possible APs contained in the terminal report 487 may be identified in priority order, in some embodiments.

In one alternative approach, the terminal report 487 is a very simple message with an indicator which indicates that the conditions in reporting configuration message 486 have been met. This has the benefit of simplicity and low signalling load.

In one embodiment, the UE 300, after reporting this simple message, associates with an AP 310 that fulfils the criteria, and sends the measurement report (terminal report 487) concerning the WLAN network 302 to the WLAN AP 310 instead, as illustrated by dashed signal 490 in FIG. 15. The WLAN side 302 can then communicate this information directly to the 3GPP side 304 or some other centralized entity that can receive information from and distribute information towards both networks. The measurement information in this terminal report 487 is then used in making the decision that will be included in the traffic steering message (message 3—488) sent from the 3GPP side 304 to the UE 300. The centralized entity could actually be aware of the context of the UE 300 in both networks and make the decision instead of the 3GPP side 304. Another possibility is for the WLAN 302 to communicate with this centralized entity to find out the UE context (e.g. amount and type of bearers, traffic volume, throughput, etc.) in the 3GPP network 304 and see if the UE 300 could be served better in the WLAN network or not, and then communicate this towards the centralized entity, which forwards this towards the 3GPP side 304.

It will be appreciated that the measurement report in signal 490 can be sent after the UE 300 associates with the WLAN AP 310.

In some embodiments of the techniques disclosed herein, the mobile terminal (UE) 300 will determine whether it has one or more Access Network Discovery and Selection Function (ANDSF) policies that indicates that a UE should refrain from connecting to a certain WLAN access point (e.g., by refraining from a certain SSID, BSSID, Extended SSID (ESSID), homogenous ESSID (HESSID), PLMN, etc.). In these embodiments, if this is the case then the terminal 300 does not include measurements for such a WLAN access point 310 in the measurement report (terminal report 487). For example, if a UE 300 is within the coverage of WLAN access point A, WLAN access point B and WLAN access point C, while having an ANDSF policy that indicates that the UE 300 should not connect to WLAN access point C, then the UE 300 would not include measurements for WLAN access point C in the terminal report 487, but will instead include measurements for WLAN access point A and WLAN access point B.

In a variant of these embodiments, the mobile terminal 300 may refrain from sending a terminal report 487 to the 3GPP network 304 unless at least one WLAN access point 310 that the mobile terminal 300 is allowed to connect to, according to the ANDSF policy, fulfils the requirements given in the reporting configuration message 486. In the example described above, the terminal 300 would refrain from sending a report to the 3GPP network 304 in the event that it has detected only WLAN access point C, since the terminal 300 is not allowed to connect to WLAN access point C according to the ANDSF policy.

In a second variant of these embodiments, the terminal 300 sends a report 487 to the 3GPP network 304 even if the terminal 300 is not, according to the ANDSF policy, allowed to connect to any of the WLAN access points that the terminal 300 has detected. So, following the example above, if the terminal 300 has only detected WLAN access point C it would still send a report 487 to the 3GPP network 304. However, the report 487 in this case would be empty, since the UE 300 is not allowed to connect to WLAN access point C.

A benefit of these embodiments, where the terminal report 487 is conditioned on the ANDSF policy, is that they help ensure that 3GPP RAN 304 does not trigger the UE 300 to steer traffic to a WLAN access point 310 that ANDSF policy has indicated that the terminal 300 should not connect to, since the 3GPP RAN 304 does not know (or learn from the terminal report 487) that the terminal 300 is within the coverage of such a WLAN access point 310. This also has the benefit of reducing the signalling load, since the size of the terminal report 487 can be reduced by excluding some measurements for WLAN access points 310 that the UE cannot (i.e. is not permitted by the ANDSF policy to) connect to. In some of the alternatives described above, the terminal 300 refrains from sending reports entirely, under certain conditions, which reduces the number of terminal reports that are sent and further reduces the amount of signalling.

In still another group of embodiments, the mobile terminal 300 determines whether it has an ANDSF policy that indicates that it should refrain from connecting to a certain WLAN access point (e.g., by refraining from a certain SSID, BSSID, ESSID, HESSID, PLMN, etc.). If this is the case, then the terminal 300 in these embodiments indicates to the 3GPP RAN 304 which WLAN access points 310 it is not allowed to connect to, according to the ANDSF policy. In contrast to some of the embodiments discussed above, however, the mobile terminal 300 may still include measurements for these WLAN access points 310 in the terminal report 487. For example, if a UE 300 is within the coverage of WLAN access point A, WLAN access point B and WLAN access point C, while having an ANDSF policy that indicates that the UE 300 should not connect to WLAN access point C, then a UE 300 configured according to these embodiments would include measurements for WLAN access point A, B & C, but indicate to the 3GPP RAN 304 that the UE 300 is not allowed to connect to WLAN access point C according to an ANDSF policy in the UE 300. This could be indicated, for example, using a bit-flag that is included in the terminal report 487 or in a related message.

In a variant of this last approach, the terminal 300 does not include the measurements of the non-allowed access points but still reports the detection and identification of non-allowed WLAN access points. With this approach, the 3GPP RAN 304 will only learn about other non-allowed WLAN access points and not know any detailed measurements. This leads to the size of the terminal reports 487 being smaller than if measurements were included for those WLAN access points.

A benefit of the embodiments where the mobile terminal 300 explicitly indicates that it is not allowed to connect to certain WLAN access points, per an ANDSF policy, is that it allows for the 3GPP RAN 304 (which conventionally does not have knowledge of the ANDSF policy) to consider that the terminal 300 has an ANDSF policy which does not allow it to connect to a certain WLAN access point 310. However, the 3GPP RAN 304 may still order the terminal 300 to steer traffic to a WLAN access point 310 even if an ANDSF policy does not allow it. The 3GPP RAN 304 could also use this indicator to try to comply to the ANDSF policy if suitable, e.g. the 3GPP RAN 304 could consider the reported information in terminal report 487 about WLAN access point A and B and, if it is judged suitable, then one of these WLAN access points 310 could be used. However if the 3GPP RAN 304 finds it more suitable to act against the ANDSF policy, it may nevertheless order the UE 300 to connect to WLAN access point C. The UE 300 may then be configured such that even if it has an ANDSF policy which indicates that it should not connect to a certain WLAN access point 310 the UE 300 should still do so if indicated by the 3GPP RAN 304 by a Traffic steering message 488 as described below.

Note that when it says herein that the UE 300 should not connect to a WLAN node 310, the policy controlling such may be explicit or implicit. In the explicit case, there may be a policy black-listing (i.e. blocking) certain WLAN access points for a UE 300, and the UE 300 is therefore not allowed to connect to these WLAN access points 310. For example, a black-list may contain WLAN access point C, in which case the UE 300 is not allowed to connect to WLAN access point C. There may be also or instead be a certain condition or conditions determining when a terminal 300 should connect to a particular WLAN access point. For example, a UE 300 may be configured to connect to WLAN access point C only if the WLAN access point C's load is below a threshold. That a UE 300 should not connect to a WLAN access points may also be given implicitly, e.g., by indicating which (other) WLAN access points the terminal 300 is allowed to connect to, like a “white-list”. Those WLAN access points not in the white-list are those that the UE 300 is implicitly not allowed to connect to. For example, a white-list could contain only WLAN access point A and WLAN access point B, which would implicitly indicate that the terminal 300 is not allowed to connect to any other WLAN access point, i.e. WLAN access point C in the given example. In the ANDSF specification (referenced above), ANDSF policies can indicate WLANs that are forbidden, meaning that a UE shall not connect to them, and WLANs that are restricted, meaning that a UE should not connect to them.

In some embodiments of the presently disclosed techniques, the network 304 can configure the behaviour of the terminal 300 with regards to any of the mobile terminal behaviours described in this section. In these embodiments, the network may indicate the wanted UE behaviour in the reporting configuration message 486, when the UE 300 performs initial access to the 3GPP network 304, for example. In other embodiments, the UE 300 may be adapted to decide for itself which of the behaviours described above should be applied. For example, the terminal 300 may determine this from the ANDSF policy or it may be autonomously decided by the terminal 300.

It should be appreciated that when the present discussion refers to an “ANDSF policy”, the term “ANDSF rule” may also be used for the same thing. There may also be a set of policies or rules provided in ANDSF. Note also that there may be other policies and/or rules and/or reasons, for not making it possible and/or wanted and/or suitable for a terminal to connect to a certain WLAN access point, aside from ANDSF. The techniques described above can also be applicable to those cases. Furthermore, it should be understood that while the above techniques are described for scenarios where the terminal should not connect to a WLAN access point according to some policy/rule/etc., a corresponding inversed logic may also be used, in some embodiments. For instance, a policy/rule/etc. may specify that a mobile terminal is allowed to connect to a certain set of WLAN access points; the policy/rule/etc. in this case indicates that the UE should not connect to any other access points.

### Message 3—Traffic Steering Message

The traffic steering message 488 is sent from the 3GPP network 304 to the terminal 300 and is used by the network to indicate to the terminal 300 that some, or all, of the terminal's traffic should be steered to WLAN 302.

The 3GPP network 304 will decide whether all or some of the terminal's bearers will be moved to one of the WLAN access points 310. In addition to the received information from the terminal the 3GPP network 304 will or may also take into account other information available in the whole network (also from other network nodes) such as information determining radio interface load, load in backhaul, what radio capabilities are used and could be used to enhance QoS. It may also collect relevant information from other WLAN access points. All relevant information can be used to determine if a move should take place. It (the 3GPP network 304) may also request information from the possible target WLAN over an interface between the 3GPP and WLAN nodes about its possibilities to serve the potential traffic (shown by arrow 491 in FIG. 15). Alternatively, the WLAN APs 310 can push the information about its possibility to serve the potential traffic to the 3GPP node 320.

It should be noted that when it here states that the 3GPP network 304 decides whether or not to move the terminal 300 to WLAN 302, the decision could be made in an entity in the 3GPP NodeB/RNC/base station controller (BSC)/eNodeB, or it may be another entity residing in another part of the 3GPP network 304. This could be for example, the centralized entity that was mentioned above in the Terminal Report section, i.e., the entity towards which the WLAN 302 has sent the measurement (terminal) report 490 that it has received from the UE 300. If the 3GPP network 304 decides to move one or more bearers to WLAN 302, it sends a message (the traffic steering message 488) to the terminal 300 indicating that the terminal 300 should move/steer traffic from the 3GPP network 304 to the WLAN network 302. This message 488 may identify which traffic, e.g. bearers, should be moved/steered (or alternatively or in addition the message 488 may identify which traffic, e.g. bearers should be kept in the 3GPP network 304. Another alternative is that the move (traffic steering) message 488 does not identify specific bearers and in such case all traffic should be moved to WLAN 302. Note that the terminal 300 may be configured such that certain types of traffic are treated in a special way during this procedure. For example, voice services have strict delay requirements and may therefore not be considered suitable to be moved to WLAN 302, the terminal 300 would then refrain from moving this service to WLAN 302. The traffic steering message 488 may indicate to the terminal 300 to which WLAN (e.g. to which WLAN AP) the traffic should be steered to. This could be achieved by indicating homogenous extended SSID (HESSID), BSSID and/or SSID in the traffic steering message 488. It is expected that if an interface between the 3GPP network 304 and the WLAN network 302 exists (e.g. shown by arrow 491) it is possible to do coordination between them prior to the steering of the terminal 300. For example the 3GPP network 304 could query the WLAN network 302 whether or not it can admit the terminal 300, and/or query the WLAN network 302 for information of expected quality of experience (QoE) or other relevant information for the terminal 300.

Alternatively, the 3GPP network 304 might just indicate to the UE 300 in the traffic steering message 488 whether to offload to WLAN 302 or not (all traffic or only a subset), and the WLAN side decides to which particular AP the UE is routed to. An intermediate way could be for the 3GPP side to decide the AP group (for example, based on PLMN, SSID, etc.), and the particular AP within that group will be chosen by the WLAN network 302.

It should be noted that if the decision was not to steer the traffic towards WLAN, a traffic steering message 488 might not necessarily have to be sent towards the UE 300. However, such a communication might be required in some instances. For example, as described in the Terminal Report section above, the terminal report (message 2) 487 can be a simple message without any measurement report and the UE associates with the AP and sends the measurement report via the WLAN networks 302. The decision whether to offload or not can then be made either by the 3GPP side upon receiving the measurement reports from the WLAN side or by the centralized entity (mentioned above) making the decision. If the decision was not to offload to WLAN 302, then this can be communicated to the UE 300 in message 3 (traffic steering message 488) and the UE 300 can then disassociate with the WLAN AP and steer the relevant traffic back to the 3GPP network 304. If the decision was to offload to WLAN 302, then this is also communicated to the UE 300 and the UE 300 will proceed with authentication and steering of the traffic as indicated in the message 488.

At various points in this document it may be mentioned that a UE is “connected” to or is “accessing” or “associated with” a WLAN. It should be appreciated that being connected to or accessing or being associated with a WLAN can mean any of several different things, as exemplified by the existence of one or more of the below conditions:
802.11 authentication (Authentication to the WLAN AP) has been completed or is under way;
802.1x extensible authentication protocol for subscriber identity module EAP-SIM authentication (Authentication to the authentication, authorisation and accounting (AAA)-servers) has been completed or is under way;
Four way hand-shake between the UE and the WLAN network has been completed;
An IP address has been assigned to the terminal in WLAN;
a packet data network (PDN) connection has been established through the WLAN network, i.e., a connection between the terminal and the PDN gateway;
Data traffic has been started through the WLAN network.

It will be appreciated that when a UE is to access, steer to traffic to or associate with a WLAN, the UE will establish or complete one or more of the above conditions in order to connect to/associate with the WLAN.

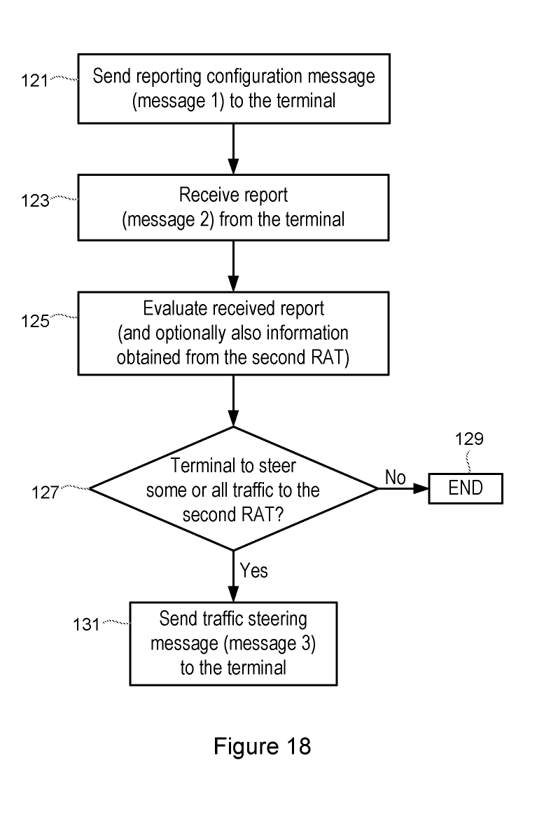

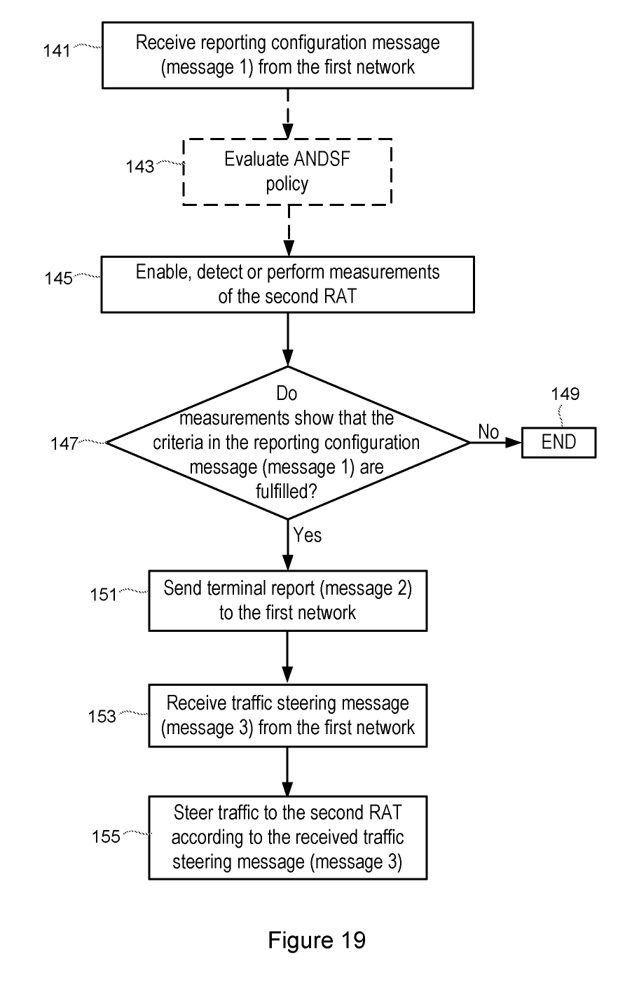

The flow charts in FIGS. 18 and 19 illustrate methods of operating a network node and terminal respectively according to several embodiments of the techniques, apparatus and systems disclosed above. The methods in FIGS. 18 and 19 expand on the methods shown in FIGS. 16 and 17 above.

In a first step of FIG. 18 (step 121), the node 320 in the first network, such as a wide area network (e.g. cellular network) sends the message 486 (message 1) to the terminal 300 with the message indicating a set of criteria for enabling, detecting, and/or performing measurements over the second RAT (the WLAN in this illustrated embodiment). This message is received by the terminal (step 141 of FIG. 19).

After receiving the reporting configuration message, the terminal 300 (optionally) evaluates one or more ANDSF policies stored in the terminal 300 (step 143), with the ANDSF policy/policies indicating certain WLAN access points that the terminal 300 should not connect to (e.g., specified as a certain SSID, BSSID, Extended SSID (ESSID), homogenous ESSID (HESSID), PLMN, etc. that the terminal 300 should not connect to).

The terminal 300 then performs the required measurements of the second RAT (step 145).

The terminal 300 then determines in step 147 if the measurements show that the criteria in the reporting configuration message are fulfilled (and that the ANDSF policy has also been complied with—if required). If not, the method ends and the terminal takes no further action (step 149). Alternatively, if the measurements show that the criteria are not fulfilled, the terminal can continue to take measurements until the criteria are fulfilled.

However, if the set of criteria in the received message are fulfilled by the measurements (and the ANDSF policy is complied with—if required), the terminal 300 sends a terminal report 487 (message 2) to the network node 320 indicating this (step 151).

The network node 320 receives this terminal report (step 123), and evaluates the contents of the report, optionally along with information obtained from the WLAN, such as information on whether the WLAN can admit the terminal 300, and/or information of the expected quality of experience (QoE) in the second network to determine whether to instruct the terminal 300 to steer all or a subset of traffic (e.g. only voice, only data, only a subset of data, etc.) to a network operating according to the second RAT (e.g. WLAN/Wi-Fi).

If no steering is required, the method in the network node ends (step 129) and the terminal 300 continues using the first (i.e. wide area) network 304.

If steering is required, the network node 320 generates and sends a traffic steering message 488 (message 3) to the terminal 300 to instruct or cause the terminal 300 to steer all or a subset of traffic (e.g. voice, data, etc.) to the WLAN 302 (step 131).

The terminal 300 receives this traffic steering message 488 (message 3) in step 153 and acts accordingly in step 155 to steer all or a subset of traffic to the network operating according to the second RAT, i.e. WLAN 302 (indicated by dashed arrow 489).

### Variations and Alternatives

In another embodiment, a UE 300 may be moving around in an area where there is both WLAN access point coverage and 3GPP RAT coverage. The UE 300 may be connected over WLAN and is served over the WLAN access network 302. Even though the above-described embodiment describes the situation where a 3GPP RAT network (e.g. eNB 320) controls the offloading towards a WLAN (e.g. an AP 310 or AC), it is of course similarly possible to reverse the situation and allow a WLAN RAT entity to control the decision to offload to a 3GPP RAT entity (i.e. the WLAN entity can send a set of criteria for enabling, detecting and/or performing measurements by the terminal 300 over the 3GPP RAT). The embodiments should not be restricted to only one of the directions.

Also, another possibility is for the 3GPP RAT 304 to control also the offloading from the WLAN 302 towards 3GPP 304. In this embodiment, the reporting configuration message 486 can additionally comprise a set of criteria for enabling, detecting, and/or performing measurements by the terminal 300 over the first RAT 304 once the terminal 300 has steered some or all of its traffic to the WLAN 302. One example realization of this is for the UE 300 to be always kept in connected mode in 3GPP (e.g. CONNECTED mode (possibly with DRX) in LTE, CELL_DCH mode (possibly with DRX) in HS/WCDMA, URA_PCH or CELL_FACH mode in HS/WCDMA with or without DRX, etc. . . . ) even when all data traffic is being routed via WLAN 302, and the UE 300 is configured with message 1 that might trigger the offloading back towards the 3GPP network 304. It is also possible to do the reverse (i.e. WLAN RAT controlling the offloading from 3GPP to WLAN).

In the first set of embodiments described above, with the fulfillment of the conditions specified in the reporting configuration message 486, the UE 300 responds with a terminal report 487. However, in a second set of embodiments, in some situations it might not be required to have the terminal report 487 and instead let the UE 300 do the offloading as soon as the criteria are fulfilled. For example, the network might configure the UE 300 with a configuration like “if RSRP of 3GPP<x and RSSI of WLAN>y, then connect to WLAN”. Such a message can be viewed as a combination of the UE reporting configuration message 486 (message 1) and UE traffic steering message 488 (message 3). Alternatively, the message could be a special message 3 telling the UE 300 to go to WLAN 302 (without any conditions), and the UE 300 does so if it can. Though such configurations are usable for both IDLE and CONNECTED UEs, they are more suitable for IDLE UEs as these UEs can't send terminal report 487 without changing their state to CONNECTED mode.

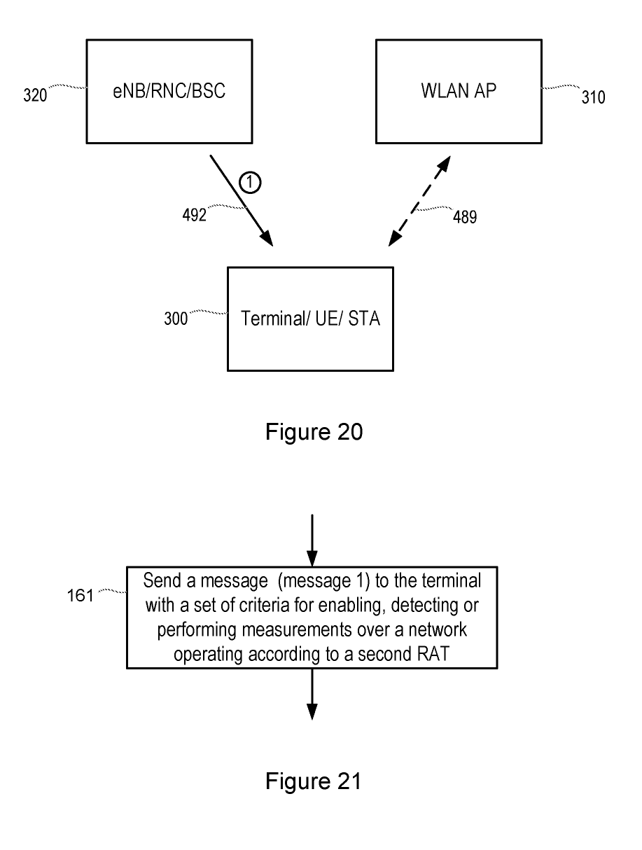

FIG. 20 illustrates the involved signalling for enabling the second set of embodiments of the techniques, apparatus and systems disclosed herein. As in the first set of embodiments above, in some embodiments the 3GPP radio access network (RAN) is in control of the mechanisms described below, i.e., the 3GPP RAN decides when message 1 should be sent, and with which contents. Also, where ANDSF policies are in use, the 3GPP RAN may not know policies maintained in the UE that are set by ANDSF, since ANDSF is usually handled on a core-network level.

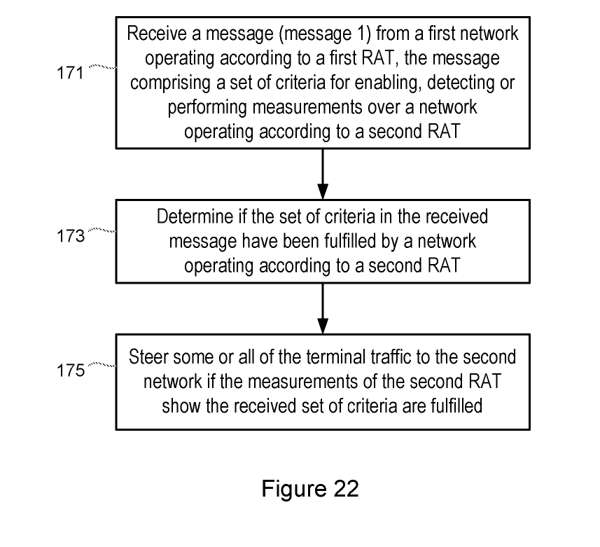

Thus, FIG. 20 illustrates the signalling between a node in a first network such as a wide area network (e.g. 3GPP) node 320, such as an eNB, RNC or BSC (as appropriate for the RAT used in the wide area network), a terminal 300 (such as a UE, STA or mobile device) and a WLAN access point 310 according to several of the second set of embodiments. It should be noted that the components 320 and 310 in FIG. 20 are also referred to more generally as the 3GPP network 304 and WLAN 302 below (although it will be appreciated that a 3GPP network and WLAN may comprise other nodes/entities to the nodes mentioned above). The flow charts in FIGS. 21 and 22 illustrate methods of operating a network node and terminal respectively according to the second set of embodiments.

In a first step of FIG. 21 (step 161), the node 320 in the wide area network sends a message 492 (message 1) to the terminal 300 with the message indicating a set of criteria for enabling, detecting and/or performing measurements over the second RAT (the WLAN in this illustrated embodiment). This message is received by the terminal (step 171 of FIG. 22).

As noted above, in addition to the set of criteria, the message 1 sent according to this set of embodiments may include an indication that the terminal 300 is to offload to the WLAN 302 as soon as the criteria are fulfilled. Alternatively, the terminal 300 can be configured to offload to the WLAN 302 as soon as the received criteria are fulfilled (in which case message 1 does not need to include this explicit indication).

Other than as described in the previous paragraph, the message 1 (492) sent according to the second set of embodiments can be as described for the first set of embodiments above.

After receiving message 1, the terminal 300 performs the required measurements of the second RAT (step 173). Step 173 can be performed as described above for the first set of embodiments, and may, in some embodiments, involve the evaluation of an ANDSF policy.

If the terminal 300 determines that the set of criteria in the received message are fulfilled, then the terminal 300 steers all or a subset of traffic (e.g. only voice, only data, only a subset of data, etc.) to the second network 302 (step 175), as indicated by dashed arrow 489. This steering can be as described above for the first set of embodiments.

It will be appreciated that where the terminal 300 evaluates an ANDSF policy in step 173, the decision in step 175 to steer all of a subset of traffic will also take into account the ANDSF policy evaluation results.

### Hardware Implementations

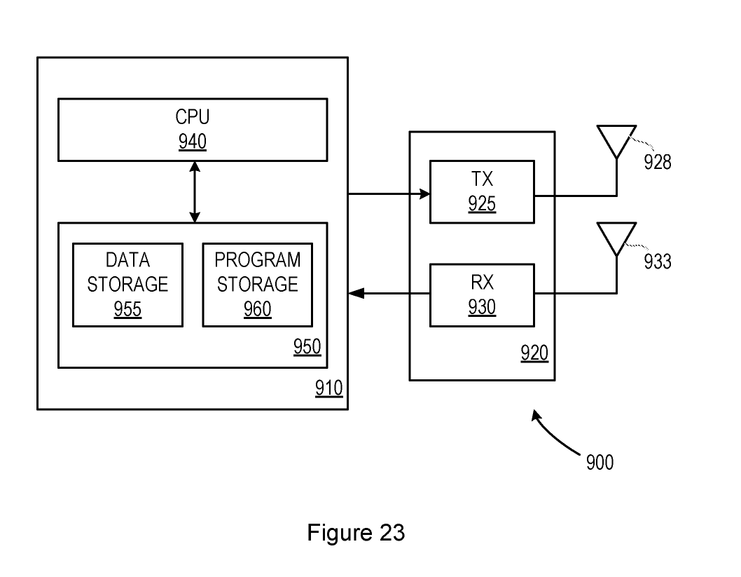

Several of the techniques and methods described above may be implemented using radio circuitry and electronic data processing circuitry provided in a terminal. FIG. 23 illustrates features of an example terminal 900 according to several embodiments of the present invention. Terminal 900, which may be a UE configured for operation with an LTE network (E-UTRAN) and that also supports Wi-Fi, for example, comprises a transceiver unit 920 for communicating with one or more base stations as well as a processing circuit 910 for processing the signals transmitted and received by the transceiver unit 920. Transceiver unit 920 includes a transmitter 925 coupled to one or more transmit antennas 928 and receiver 930 coupled to one or more receiver antennas 933. The same antenna(s) 928 and 933 may be used for both transmission and reception. Receiver 930 and transmitter 925 use known radio processing and signal processing components and techniques, typically according to a particular telecommunications standard such as the 3GPP standards for LTE. Note also that transmitter unit 920 may comprise separate radio and/or baseband circuitry for each of two or more different types of radio access network, such as radio/baseband circuitry adapted for E-UTRAN access and separate radio/baseband circuitry adapted for Wi-Fi access. The same applies to the antennas—while in some cases one or more antennas may be used for accessing multiple types of networks, in other cases one or more antennas may be specifically adapted to a particular radio access network or networks. Because the various details and engineering tradeoffs associated with the design and implementation of such circuitry are well known and are unnecessary to a full understanding of the invention, additional details are not shown here.

Processing circuit 910 comprises one or more processors 940 coupled to one or more memory devices 950 that make up a data storage memory 955 and a program storage memory 960. Processor 940, identified as CPU 940 in FIG. 23, may be a microprocessor, microcontroller, or digital signal processor, in some embodiments. More generally, processing circuit 910 may comprise a processor/firmware combination, or specialized digital hardware, or a combination thereof. Memory 950 may comprise one or several types of memory such as read-only memory (ROM), random-access memory, cache memory, flash memory devices, optical storage devices, etc. Because terminal 900 supports multiple radio access networks, processing circuit 910 may include separate processing resources dedicated to one or several radio access technologies, in some embodiments. Again, because the various details and engineering tradeoffs associated with the design of baseband processing circuitry for mobile devices are well known and are unnecessary to a full understanding of the invention, additional details are not shown here.

Typical functions of the processing circuit 910 include modulation and coding of transmitted signals and the demodulation and decoding of received signals. In several embodiments of the present invention, processing circuit 910 is adapted, using suitable program code stored in program storage memory 960, for example, to carry out one of the techniques described above for access network selection. Of course, it will be appreciated that not all of the steps of these techniques are necessarily performed in a single microprocessor or even in a single module.

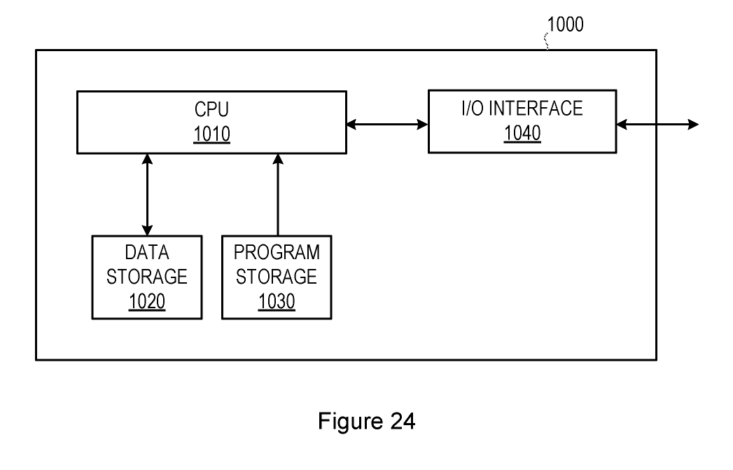

Similarly, several of the techniques and processes described above can be implemented in a network node, such as an eNodeB or other node in a 3GPP network. FIG. 24 is a schematic illustration of a node 1000 in which a method embodying any of the presently described network-based techniques can be implemented. A computer program for controlling the node 1000 to carry out a method embodying the present invention is stored in a program storage 1030, which comprises one or several memory devices. Data used during the performance of a method embodying the present invention is stored in a data storage 1020, which also comprises one or more memory devices. During performance of a method embodying the present invention, program steps are fetched from the program storage 1030 and executed by a Central Processing Unit (CPU) 1010, retrieving data as required from the data storage 1020. Output information resulting from performance of a method embodying the present invention can be stored back in the data storage 1020, or sent to an Input/Output (I/O) interface 1040, which includes a network interface for sending and receiving data to and from other network nodes and which may also include a radio transceiver for communicating with one or more terminals.

Accordingly, in various embodiments of the invention, processing circuits, such as the CPU 1010 in FIG. 24, are configured to carry out one or more of the techniques described in detail above. Likewise, other embodiments include radio network controllers including one or more such processing circuits. In some cases, these processing circuits are configured with appropriate program code, stored in one or more suitable memory devices, to implement one or more of the techniques described herein. Of course, it will be appreciated that not all of the steps of these techniques are necessarily performed in a single microprocessor or even in a single module.

The disclosed techniques enable a good load balancing between the 3GPP NW and WLAN NW ensuring users with best possible service levels by allowing the network to control whether a terminal steers traffic to WLAN. It also allows for the network to control when the terminal steers traffic from 3GPP to WLAN. Some embodiments also facilitate efficient interworking between the RAN solution for access network selection and ANDSF policies in the UE. This is beneficial, since ANDSF policies are handled in the core network and the RAN may not know anything about how these policies have been set.

It will be appreciated by the person of skill in the art that various modifications may be made to the above described embodiments without departing from the scope of the present invention. For example, it will be readily appreciated that although the above embodiments are described with reference to parts of a 3GPP network, an embodiment of the present invention will also be applicable to like networks, such as a successor of the 3GPP network, having like functional components. Therefore, in particular, the terms 3GPP and associated or related terms used in the above description and in the enclosed drawings and any appended claims now or in the future are to be interpreted accordingly.

Examples of several embodiments of the present invention have been described in detail above, with reference to the attached illustrations of specific embodiments.

Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

1-36. (canceled)

37. A method of operating a terminal in a first network that is operating according to a first radio access technology (RAT) the method comprising:
receiving a message from the first network, the message indicating a set of criteria for enabling, detecting and/or performing measurements over a second RAT;
determining whether the set of criteria in the message are fulfilled by a network operating according to a second RAT; and
steering all or a subset of the traffic for the terminal to the network operating according to the second RAT in response to determining that the set of criteria are fulfilled.

38. The method of claim 37, wherein the step of determining whether the set of criteria in the message are fulfilled comprises performing measurements of a network operating according to a second RAT and comparing the measurements to the set of criteria in the message.

39. The method of claim 37, further comprising the steps of:
evaluating an Access Network Discovery and Selection Function (ANDSF) policy; and
determining whether to steer all or a subset of the traffic for the terminal to a network operating according to the second RAT using the measurements and the result of the evaluation of the ANDSF policy.

40. The method of claim 39, wherein the ANDSF policy indicates one or more networks operating according to the second RAT and/or one or more nodes in a network operating according to the second RAT that the terminal should not connect to.

41. The method of claim 37, further comprising the step of receiving, from the first network, information on limitations to which frequencies are to be scanned and/or information as to limitations of valid wireless local area networks (WLANs) and/or WLAN access points (APs).

42. The method of claim 37, wherein the message received from the first network further comprises a set of criteria for enabling, detecting, and/or performing measurements over the first RAT once the terminal has steered all or a subset of its traffic to a network operating according to the second RAT.

43. A terminal for use in a first network that is operating according to a first radio access technology (RAT) the terminal comprising:
a transceiver configured to communicate with two or more types of radio access network; and
a processing circuit configured to:
receive a message from the first network, the message indicating a set of criteria for enabling, detecting and/or performing measurements over a second RAT;
determine whether the set of criteria in the message are fulfilled by a network operating according to a second RAT; and
steer all or a subset of the traffic for the terminal to the network operating according to the second RAT in response to determining that the set of criteria are fulfilled.

44. The terminal of claim 43, wherein the processing circuit is configured to determine whether the set of criteria in the message are fulfilled by performing measurements of a network operating according to a second RAT and comparing the measurements to the set of criteria in the message.

45. The terminal of claim 43, wherein the processing circuit is further configured to:
evaluate an Access Network Discovery and Selection Function (ANDSF) policy; and
determine whether to steer all or a subset of the traffic for the terminal to a network operating according to the second RAT using the measurements and the result of the evaluation of the ANDSF policy.

46. The terminal of claim 43, wherein the message received from the first network further comprises a set of criteria for enabling, detecting, and/or performing measurements over the first RAT once the terminal has steered all or a subset of its traffic to a network operating according to the second RAT.

47. A network node for use in a first radio access network operating according to a first radio access technology (RAT) the network node comprising:
a radio transceiver configured to communicate with one or more terminals; and
a processing circuit configured to send a message to a terminal, the message indicating to the terminal a set of criteria for enabling, detecting and/or performing measurements over a network operating according to a second RAT.

48. The network node as in claim 47, wherein the message further comprises an indication that the terminal is to steer all or a subset of its traffic to the network operating according to the second RAT in response to determining that the set of criteria in the message is fulfilled.

49. The network node as in claim 47, wherein the processing circuit is further configured to:
receive a report from the terminal when the criteria in the message have been fulfilled; and
send a message to the terminal, the message comprising an indicator that the terminal should steer all or a subset of its traffic to the network operating according to the second RAT.

50. A method of operating a terminal in a first network that is operating according to a first radio access technology (RAT) the method comprising:
receiving a message from the first network, the message indicating a set of criteria for enabling, detecting and/or performing measurements over a network operating according to a second RAT;
sending a report to the first network in response to determining that the criteria in the message have been fulfilled; and
receiving a message from the first network, the message comprising an indicator that the terminal should steer all or a subset of its traffic to a network operating according to the second RAT.

51. The method of claim 50, further comprising the steps of:
evaluating an Access Network Discovery and Selection Function (ANDSF) policy; and
indicating a result of the evaluation of the ANDSF policy in the report sent to the first network.

52. The method of claim 50, wherein the report sent to the first network comprises an indication that at least one node in a network operating according to a second RAT has met the criteria.

53. The method of claim 50, the method further comprising the step of steering all or a subset of the terminal's traffic to the network operating according to the second RAT in response to determining that the set of criteria in the received message are fulfilled.
